(19) United States
(12) Patent Application Publication
(10) Pub. No.: US 2025/0103682 A1
(43) Pub. Date: Mar. 27, 2025

(54) DETERMINING AND PERFORMING OPTIMAL ACTIONS ON A PHYSICAL SYSTEM

(71) Applicant: Microsoft Technology Licensing, LLC, Redmond, WA (US)

(72) Inventors: Chao MA, Cambridge (GB); Cheng ZHANG, Cambridge (GB); Colleen TYLER, Redmond, WA (US); Marife DEFANTE, Woodinville, WA (US); Lisa Lynne PARKS, Redmond, WA (US); Agrin Aram HILMKIL, Stockholm (SE); Nick PAWLOWSKI, Cambridge (GB)

(21) Appl. No.: 18/399,681

(22) Filed: Dec. 28, 2023

Related U.S. Application Data
(60) Provisional application No. 63/584,484, filed on Sep. 21, 2023.

(51) Int. Cl. G06F 17/18; G06F 17/16

(52) U.S. Cl. CPC G06F 17/18; G06F 17/16

(57) ABSTRACT

A computer-implemented method is provided. A dataset comprising a covariate matrix, a treatment vector, and an outcome vector is received. Using a trained causal model applied to the dataset, an inverse probability weighted (IPW) model estimation of treatment effect is generated. An inverse probability weighted estimation of groundtruth treatment effect is computed. A causal treatment error is calculated based on the inverse probability weighted model estimation of treatment effect and the inverse probability weighted estimation of groundtruth treatment effect.

### TECHNICAL FIELD

The present disclosure relates to methods and systems for determining and performing optimal actions on a physical system.

### BACKGROUND

Causal inference is a fundamental problem with wide ranging real-world applications in fields such as manufacturing, engineering and medicine. Causal inference involves estimating a treatment effect of actions on a system (such as interventions or decisions affecting the system). This is particularly important for real-world decision makers, not only to measure the effect of actions, but also to pick the best action that is the most effective.

For example, in the manufacturing industry, causal inference can help quantitatively identify the impact of different factors that affect product quality, production efficiency, and machinery performance in manufacturing processes. By understanding causal relationships between these factors, manufacturers can optimize their processes, reduce waste, and improve overall efficiency. As another example, in the field of engineering, causal inference can be used for root cause analysis and identify underlying causes of faults and malfunctions in machines or electronic systems such as vehicles or unmanned drones (e.g. aircraft systems).

By analyzing data from sensors, maintenance records, and incident reports, causal inference methods can help determine which factors are responsible for observed issues and guide targeted maintenance and repair actions. In genome-wide association studies (GWAS), causal inference may be used, for example, to associate between genetic variants and a trait or disease, accounting for potential confounding factors, which in turn may allow therapeutic treatments to be developed or refined.

### SUMMARY

Herein, using a causal model evaluation with non-RCT, a novel method for low-variance estimation of causal error is provided, and its effective over current approaches demonstrated by achieving near-RCT performance. To estimate the causal error, a simple and effective low-variance estimation procedure is provided without improving the IPW estimator for the true treatment effect.

Specifically, a trained causal model is applied to a dataset comprising a covariate matrix, a treatment vector, and an outcome vector. The model then generates an inverse probability weighted (IPW) model estimation of treatment effect. An inverse probability weighted estimation of groundtruth treatment effect is also computed. An error based on the inverse probability weighted model estimation of treatment effect and the inverse probability weighted estimation of groundtruth treatment effect can then be found. Based on the error, a treatment, for example a change in the system being monitored and from which the dataset was obtained, can be determined and applied.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 provides an example method for calculating a causal error;

FIG. 2 illustrates a method for obtaining a causal error estimator;

FIG. 3 provides a comparison of various causal error estimators for a logistic assignment scheme;

FIG. 4 provides a comparative analysis of multiple causal error estimators in the context of a random subsampling scheme;

FIG. 5 shows the performance of different causal error estimators across different causal inference methods;

FIG. 6 shows causal error estimator quality metrics for across common causal methods;

FIG. 7 provides an overview of causal inference;

FIG. 8 illustrates domain-specific causal inference approaches;

FIG. 9 illustrates a forward mode;

FIG. 10 illustrates training a causal model using a single data set;

FIG. 11 illustrates training the causal model using multiple data sets;

FIG. 12 illustrates rebalancing at test time/inference using the trained causal inference model;

FIG. 13 illustrates the inference time; and

FIG. 14 is a schematic diagram of a computing device.

### DETAILED DESCRIPTION

Particular embodiments will now be described, by way of example only.

Causal inference has numerous real-world applications. Causal inference may interface with the real-world in term of both its inputs and its outputs/effects. For example, multiple candidate actions may be evaluated via causal inference, in order to select an action (or subset of actions) of highest estimated effectiveness, and perform the selected action on a physical system(s) resulting in a tangible, real-world outcome. Input may take the form of measurable physical quantities such as energy, material properties, processing, usage of memory/storage resources in a computer system, therapeutic effect etc. Such quantities may, for example, be measured directly using a sensor system or estimated from measurements of another physical quantity or quantities.

For example, different energy management actions may be evaluated in a manufacturing or engineering context, or more generally in respect of some energy-consuming system, to estimate their effectiveness in terms of energy saving, as a way to reduce energy consumption of the energy-consuming system. A similar approach may be used to evaluate effectiveness of an action on a resource-consuming physical system with respect to any measurable resource.

A ‘treatment’ refers to an action performed on a physical system. Testing may be performed on a number of ‘units’ to estimate effectiveness of a given treatment, where a unit refers to a physical system in a configuration that is characterized by one or more measurable quantities (referred to as ‘covariates’). Different units may be different physical systems, or the same physical system but in different configurations characterized by different (sets of) covariates. Treatment effectiveness is evaluated in terms of a measured ‘outcome’ (such as resource consumption. Outcomes are measured in respect of units where treatment is varied across the units. For example, in one a ‘binary’ treatment set up, a first subset of units (the “treatment group’) receives a given treatment, whilst a second subset of units (the ‘control group’) receives no treatment, and outcomes are measured for both). More generally, units may be separated into any number of test groups, with treatment varied between the test groups.

A challenge when evaluating effectiveness of actions is separating causality from mere correlation. Correlation arises from ‘confounders’, which are variables that can create a misleading or spurious association between two or more other variables. When confounders are not properly accounted for, their presence can lead to incorrect conclusions about causality.

One approach to this issue involves randomized experiments, such as A/B testing (also known as randomized control trials). With this approach, units subject to testing are randomly assigned to different variations, as a way to reduce bias. A/B testing attempts to address the issue of confounders by attempting to give even representation to confounders across the different test groups. In principle, this does not require confounders to be explicitly identified, provided the test groups are truly randomized.

There are three common methods to identify causal effects, including i) randomized experiments (A/B testing); ii) expert knowledge/existing knowledge; iii) observational study (building quantitative causal models solely based on non-experimental data). However, these methods lack flexibility, and are often not be feasible in practice due to either costs (too expensive to experiment), feasibility (not enough domain knowledge or non-experimental data) and/or ethical reasons, etc. Moreover, these methods/models are highly scenario-specific, for instance the causal model built for performing GWAS task cannot be re-used for the purpose of root cause analysis in the aerospace industry.

In reality, truly randomized A/B testing may be challenging to implement in practice. Firstly, this approach generally requires an experiment designer to have control over the allocation of units to test groups, to ensure allocations are randomized. Moreover, even when an experiment designer has such control, it is often challenging to ensure truly randomized allocation.

Herein, an alternative method is described that addresses these technical problems, namely the use of a causal model for causal inference.

Causal inference models may be used to estimate casual effect from an imperfect, non-randomized dataset of the form {xi, Ti, Yi}_{1≤i≤N}, where xi denotes a set of D observed covariates (where D is one or more) of the i^{th} unit, Tᵢ denotes a treatment observation for the i^{th} unit (e.g. an indication of whether or not a given treatment was applied to that unit), and Yᵢ denotes an outcome observed in respect of the i^{th} unit. In the following, X denotes an N×D matrix of covariates across the N units, T denotes an N-dimensional treatment vector containing the treatment observations across the N units and Y denotes an N-dimensional vector of the N observed outcomes.

A causal error estimation mechanism is described herein, which can be used to test if a trained causal inference model is accurate, though high precision causal model evaluation with non-randomized trials.

In one application, the causal error estimation may be applied to select a causal model from a set of candidate causal models, by estimating the causal error of each of them, and selecting a lowest-error causal model.

As discussed, a gold standard for causal model evaluation involves comparing model predictions with true effects estimated from randomized controlled trials (RCT). However, RCTs are not always feasible or ethical to perform. In contrast, non-randomized experiments based on inverse probability weighting (IPW) offer a more realistic approach but may suffer from high estimation variance. To tackle this challenge and enhance causal model evaluation in real-world non-randomized settings, a novel low-variance estimator for causal error is provided, referred to as the pairs estimator. By applying the same IPW estimator to both the model and true experimental effects, the pairs estimator effectively cancels out the variance due to IPW and achieves a smaller asymptotic variance. Empirical studies demonstrate the improvement of the estimator, highlighting its potential on achieving near-RCT performance. This method offers a simple yet powerful technical solution to evaluate causal inference models in non-randomized settings without complicated modification of the IPW estimator itself, paving the way for more robust and reliable model assessments.

This technology can be applied to novel scenarios whenever causal effects needs to be identified. In a manufacturing industry, for example, the aim is to quantitatively identify the impact from different factors that affect product quality, production efficiency, and machinery performance in manufacturing processes. Given a quantitative causal model and certain amount of trial data, the method provided herein would allow better and faster understanding of how well this model can predict certain the causal relationships between these factors, companies can optimize their processes, reduce waste, and improve overall efficiency. The aerospace industry provides another example, in which root cause analysis is crucial to identify the underlying causes of faults and malfunctions in aircraft systems. The method provided herein can help evaluating which root cause analysis method is the most efficient for guiding targeted maintenance and repair actions, by analyzing experimental data from sensors, maintenance records, and incident reports, causal inference methods. As a further example, in genome-wide association studies (GWAS), it is crucial to test our hypothesis that associate between genetic variants and the trait or diseases. This method would accelerate the process of validating those assumptions via experimental data.

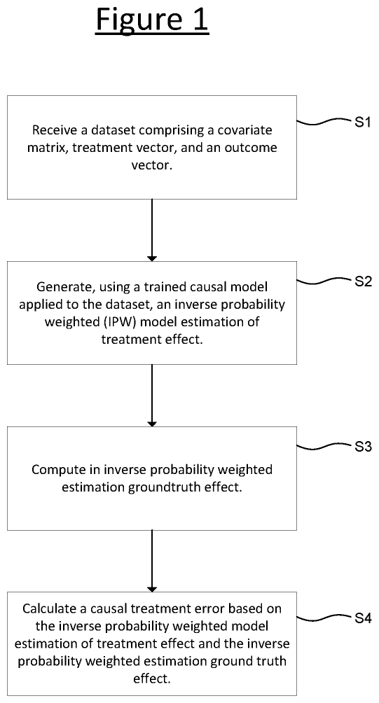

FIG. 1 provides an example method for estimating causal error according to embodiments described herein.

At step S1, a dataset comprising a covariate matrix, a treatment vector, and an outcome vector is received. At step S2, using a trained causal model applied to the dataset, an inverse probability weighted (IPW) model estimation of a treatment effect is generated. At step S3, an inverse probability weighted estimation of a groundtruth treatment effect is estimated. At step S4 a causal treatment error is calculated based on the inverse probability weighted model estimation of the treatment effect and the inverse probability weighted estimation of the groundtruth treatment effect.

Example trained causal models which may be used to compute the IPW model estimation of treatment effect are provided below. Some examples include a trained propensity score model, a trained model for used in a difference-in-difference method, a trained outcome model, and a causal foundation model. Each of these trained models take, as input, the received dataset comprising the covariate matrix, the treatment vector, and the outcome vector, and process the dataset to compute the IPW estimation of the treatment effect. The way in which the models process the datasets is set out in more detail below.

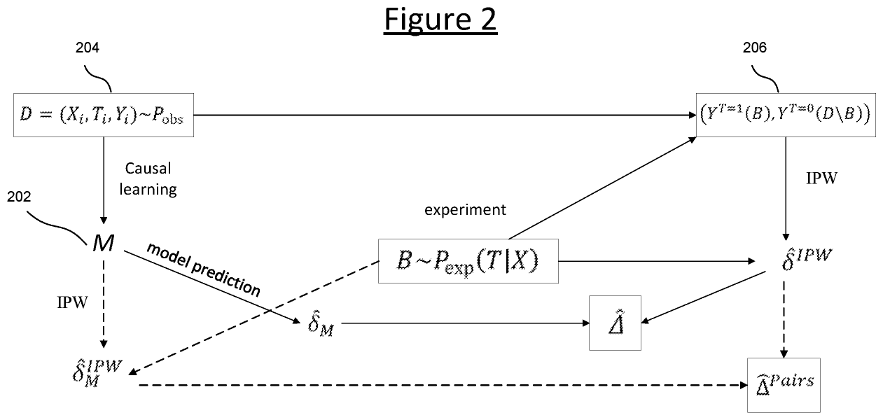

The IPW model estimation of the treatment effect is a prediction generated by the trained causal model. The IPW estimation of the groundtruth treatment effect, on the other hand, is an estimation derived from actual, groundtruth, data, and in particular from the outcome vector of the received dataset. The causal treatment error can be calculated as the difference between these two estimations, as shown in FIG. 2.

As shown in FIG. 2, the ground truth effect is denoted as δ and the treatment effect of a causal model M as δ_{M}. The goal is to estimate the causal treatment error \hat{Δ}:=\hat{δ}_{M}−\hat{δ}^{IPW} with low variance. Using non-randomized experiments, there is an estimator of the ground truth via IPW: \hat{δ}^{IPW} (the IPW estimation of the groundtruth treatment effect). Instead of improving the IPW estimator, the commonly used sample mean estimator \hat{δ}_{M} is replaced with its IPW counterpart, \hat{δ}_{M}^{IPW} (the IPW model estimation of the treatment effect), having the same realizations of treatment assignments as in \hat{δ}^{IPW}. This allows the variance of \hat{δ}^{IPW} to be hedged by \hat{δ}_{M}^{IPW}, reducing the variance of the causal treatment error estimator \hat{Δ}. Contrary to conventional estimation strategies, the pairs estimator \hat{Δ}^{Pairs}, as it is also referred to herein, effectively reduces the variance of the causal error estimation and provides more reliable evaluations of causal model quality, both theoretically and empirically.

It can be seen in FIG. 2 that the data set D=(Xᵢ, Tᵢ, Yᵢ) 204 is provided as input to the trained causal model 202 to generate the model prediction of treatment effect δ_{M}, to which IPW is applied, thereby generating the IPW model estimation of the treatment effect \hat{δ}_{M}^{IPW} using:

$${\hat{δ}}_{M}^{IPW} ( T ) := \frac{1}{N} 〈 {Y}_{M}^{T = 1} ( B ) , w ( B ) 〉 - \frac{1}{N} 〈 {Y}_{M}^{T = 0} ( D \backslash B ) , \frac{w ( D \backslash B )}{w ( D \backslash B ) - 1} 〉$$

The IPW estimation of the groundtruth treatment effect \hat{δ}^{IPW} is derived from the groundtruth data 206, obtained from the dataset 206. As discussed below, the IPW estimation of groundtruth can be approximated using a population mean of potential outcomes. The IPW estimation of the groundtruth can be written as:

$${\hat{δ}}^{IPW} ( T ) := \frac{1}{N} 〈 {Y}^{T = 1} ( B ) , w ( B ) 〉 - \frac{1}{N} 〈 {Y}^{T = 0} ( D \backslash B ) , \frac{w ( D \backslash B )}{w ( D \backslash B ) - 1} 〉$$

Thus, the pairs estimator \hat{Δ}^{Pairs}, or causal treatment error, can be calculated by

$${\hat{Δ}}^{Pairs} ( M , T ) := {\hat{δ}}_{M}^{IPW} ( T ) - {\hat{δ}}^{IPW} ( T ) .$$

As discussed in more detail later, the causal treatment error may be used to determine a treatment, also referred to as a treatment action, for a physical system, to which it is subsequently applied.

Multiple trained causal models may be provided with the dataset 204 as input, and process the dataset 204 to generated a respective IPW estimation of the treatment effect. For each of these models, a respective causal treatment effect error can be calculated, using the IPW estimation of the groundtruth treatment effect. In this case, the respective causal treatment effect errors are used to select one of the causal models, and then the selected causal model used to determine the treatment for the physical system. For example, the trained causal model associated with the lowest causal error may be selected from the multiple trained causal models, and the treatment determined using said selected model.

### Problem Formulation

Consider the data generating distribution for the population on which the experiment is being carried over is given by p(X, T, Y), where X are some (multi-variate) covariates, Y is the outcome variable, and T is the treatment variable. Herein, only continuous effect outcomes are considered. Let Y^{T=t} denote the potential outcome of the effect variable under the intervention T=t. Without loss of generality, it is assumed that T∈{0,1}. Then, the interventional means are given by μ¹= [symbol] [Y^{T=1}], and μ⁰= [symbol] [Y^{T=0}], respectively. The ground truth treatment effect is then given by δ=μ¹−μ⁰= [symbol] [Y^{T=1}]− [symbol] [Y^{T=0}]. Now, assume that given observational data sampled from p(X, T, Y), we have trained a causal model, denoted by M, whose treatment effect is given by δ_{M}=μ_{M}¹−μ_{M}⁰= [symbol] [Y_{M}^{T=1}]− [symbol] [Y_{M}^{T=0}]. The goal is then to estimate the causal error of the model, which quantifies how well the model reflects the true effects (the closer to zero, the better): Δ(M):=δ_{M}−δ.

In practice, δ_{M} will be the model output, and can be estimated easily. For instance, a pool of i.i.d. subjects D=(X₁, Y₁), . . . , (X_{N}, Y_{N})˜p(X, Y) can be sampled, and the corresponding treatment effect estimation will be given as

$${δ}_{M} \approx {\hat{δ}}_{M} = \frac{1}{N} {\sum }_{i ∈ D} [ {Y}_{M}^{T = 1} ( i ) - {Y}_{M}^{T = 0} ( i ) ] ,$$

which forms the basics of many casual inference methodologies, both for potential-outcome approaches and structural causal model approaches [Rubin, 1974, Rosenbaum and Rubin, 1983, Rubin, 2005, Pearl et al., 2000]. On the contrary, obtaining the ground truth effect δ is usually not possible without real-world experiments/interventions, due to the fundamental problem of causal inference [Imbens and Rubin, 2015]. By definition, δ can be (hypothetically) approximated by the population mean of potential outcomes:

$$δ \approx \hat{δ} := \frac{1}{N} {\sum }_{i ∈ D} [ {Y}^{T = 1} ( i ) - {Y}^{T = 0} ( i ) ] .$$

However, given a subject i, only one version of the potential outcomes can be observed. Therefore, the experimental approach is often used—the randomized controlled trial (RCT). The RCT approach is considered in the art as the golden standard for treatment effect estimation, in which treatments are randomly assigned to the pool of subjects D=(X₁, Y₁), . . . , (X_{N}, Y_{N})˜p(X, Y), by flipping an unbiased coin. Then the estimated treatment effect is given by:

$${\hat{δ}}^{RCT} = \frac{1}{\vert B \vert} {\sum }_{i ∈ B} {Y}^{T = 1} ( i ) - \frac{1}{N - \vert B \vert} {\sum }_{j ∈ D \backslash B} {Y}^{T = 0} ( j ) ,$$

where B denotes the subset of patients that are assigned with the treatment. Together, this results in the RCT estimator of the causal error: \hat{Δ}^{RCT}(M):=\hat{δ}_{M}−\hat{δ}^{RCT}.

However, when a randomized trial is not available, a non-randomized test assignment plan is deployed, represented by T, which is a vector of n Bernoulli random variables T=[b₁, b₂, . . . bₙ], each determining that Y^{T=1}(j) will be revealed with probability pⱼ, for j∈{1, . . . n}. In practice, T can be either given by an explicit treatment assignment model pₑₓₚ(T=1|X) or manually specified on a case-by-case basis for each subject in the pool D. A subset of patients B∈D is selected given these probabilities. Then, the inverse probability weighted (IPW) estimation of the treatment effect is given by

$${\hat{δ}}^{IPW} ( T ) := \frac{1}{N} 〈 {Y}^{T = 1} ( B ) , w ( B ) 〉 - \frac{1}{N} 〈 {Y}^{T = 0} ( D \backslash B ) , \frac{w ( D \backslash B )}{w ( D \backslash B ) - 1} 〉 ,$$

$$where w = [ \frac{1}{{p}_{1}} , \frac{1}{{p}_{2}} , ... \frac{1}{{p}_{N}} ]$$

is a vector of inverse probabilities and w(B) is created by sub-slicing w with subject indices in B. The inner product is given by [symbol] ⋅,⋅ [symbol] , and 1 is a vector of ones. The division in the inner product is performed term-wise, whereby if

$$w ( B ) = [ \frac{1}{{p}_{1}} , \frac{1}{{p}_{2}} ] ,$$

$$then \frac{w ( B )}{w ( B ) - 1} = [ \frac{{p}_{1}}{1 - {p}_{1}} , \frac{{p}_{2}}{1 - {p}_{2}} ] .$$

Finally, the model causal error can be estimated as (referred to naive estimator herein): \hat{Δ}(M, T):=\hat{δ}_{M}−\hat{δ}^{IPW}(T).

In practice, when the size N of the subject pool is relatively small, the IPW estimated treatment effect \hat{δ}^{IPW}(T) will have high variance especially when pₑₓₚ(T=1|X) is skewed. As a result, one will expect a very high or even unbounded variance in the estimation [Khan and Tamer, 2010, Busso et al., 2014] \hat{Δ}(M, T).

The methods provided herein improve model quality estimation strategy \hat{Δ}(M, T) such that it has lower variance and error rates under non-randomized trials.

### Pairs Estimator for Causal Model Quality Evaluation the Pairs Estimator

To resolve the problems with the naive estimator for causal error set out above, a novel estimator is provided which significantly improves the causal error estimation quality in a model-agonist way. Intuitively, when estimating \hat{Δ}(M, T), the same IPW estimator (with the same treatment assignment) can be applied for both the model treatment effect δ_{M} and the ground truth treatment effect δ. In this way, the estimators for δ_{M} and δ become comparable; their estimation error will be cancelled out and hence the overall variance is lowered. More formally, the following definition applies:
Assume there is a pool of i.i.d. subjects to be tested, namely D=(X₁, Y₁), . . . , (X_{N}, Y_{N})˜p(X, Y), as well as a non-randomized treatment assignment plan, represented by T, which is a vector of n Bernoulli random variables T=[b₁, b₂, . . . bₙ], each determining that Y^{T=1}(j) will be revealed with probability pⱼ for j∈{1, . . . n}. Assume that, for a particular trial, a subset of patients B∈D are selected using these probabilities. Then, the IPW estimator of the model's treatment effect and the ground truth treatment effect is given by

$${\hat{δ}}_{M}^{IPW} ( T ) := \frac{1}{N} 〈 {Y}_{M}^{T = 1} ( B ) , w ( B ) 〉 - \frac{1}{N} 〈 {Y}_{M}^{T = 0} ( D \backslash B ) , \frac{w ( D \backslash B )}{w ( D \backslash B ) - 1} 〉 , and$$

$${\hat{δ}}^{IPW} ( T ) := \frac{1}{N} 〈 {Y}^{T = 1} ( B ) , w ( B ) 〉 - \frac{1}{N} 〈 {Y}^{T = 0} ( D \backslash B ) , \frac{w ( D \backslash B )}{w ( D \backslash B ) - 1} 〉 ,$$

respectively. Then, the pairs estimator of causal model quality is defined as

$${\hat{Δ}}^{Pairs} ( M , T ) := {\hat{δ}}_{M}^{IPW} ( T ) - {\hat{δ}}^{IPW} ( T ) .$$

In the equation above, it can be seen that the causal treatment error \hat{Δ}^{Pairs}(M, T) is calculated based on the inverse probability weighted model estimation of treatment effect \hat{δ}_{M}^{IPW}(T) and the inverse probability weighted estimation of groundtruth treatment effect \hat{δ}^{IPW}(T).

This new estimator can effectively reduce estimation error. It is assumed by default that the common assumptions for non-randomized experiments will hold, such as non-interference/consistency/overlap, etc, even though these assumptions are not explicitly mentioned below.

### Core Assumptions for Achieving Variance Reduction

The main assumption is regarding the estimation error of causal models, stated as below.

### Assumption A: Causal Model Estimation Error for Potential Outcomes

It is assumed that for each subject i, the trained causal model's potential outcome estimation can be expressed as

$${Y}_{M}^{T = t} ( i ) = {Y}^{T = t} ( i ) + {V}_{i} ( {Y}^{T = t} ( i ) ) * {v}_{i} , i = 1 , 2 , ... N , t ∈ \{ 0 , 1 \} ,$$

where vᵢ are i.i.d. distributed random error variables with unknown variance σᵥ², that is independent from Yᵢ^{T=t} and bᵢ; and Vᵢ(⋅), i=1,2, . . . N is a set of deterministic functions that are indexed by i. This assumption is very general and models the modulation effect between the independent noise v and the ground truth counterfactual. One special example would be Y_{M}^{T=t}(i)=Y^{T=t}(i)+Y^{T=t}(i)*vᵢ, where the estimation error will increase (on average) as Y^{T=t} increases. In practice, dependencies between error magnitude and ground truth value could arise when the model is trained on observational data that suffers from selection bias, measurement error, omitted variable bias, etc. Herein, this equation is given in its vectorized form:

$${Y}_{M}^{T = t} = {Y}^{T = t} + V ( {Y}^{T = t} ) * v ,$$

where all operations are point-wise. Finally, it is desirable that the causal model's counterfactual prediction is somewhat reasonable, in the sense that

$${σ}_{v}^{2} 𝔼 [ {( {V}_{i} {Y}^{T = t} ( i ) )}^{2} ] < 𝔼 [ {{Y}^{T = t} ( i )}^{2} ] , t = 1 , 0 ; i = 1 , 2 , ... N .$$

This implies that the variance of the estimation error should at least be smaller than the ground truth counterfactual

### Assumption B: Asymptotic Normality of Mean Estimators of Potential Outcome Variables

This particular assumption is mainly for achieving asymptotic normality of the estimators, which is orthogonal to achieving variance reduction effect of the pairs estimator, that relies on Assumption A.

Let Y̅^̅{̅T̅=̅1̅}̅, Y̅^̅{̅T̅=̅0̅}̅, Y̅_̅{̅M̅}̅^̅{̅T̅=̅1̅}̅, Y̅_̅{̅M̅}̅^̅{̅T̅=̅0̅}̅ be the corresponding mean estimator of the potential outcome variables Y^{T=1}, Y^{T=0}, T_{M}^{T=1}, Y_{M}^{T=0}. It is assumed that these estimators are jointly asymptotic normal, i.e.,

$$\sqrt{N} ( \overline{{Y}^{T = 1}} - 𝔼 {Y}^{T = 1} , \overline{{Y}^{T = 0}} - 𝔼 {Y}^{T = 0} , \overline{{Y}_{M}^{T = 1}} - 𝔼 {Y}_{M}^{T = 1} , \overline{{Y}_{M}^{T = 0}} - 𝔼 {Y}_{M}^{T = 0} )$$

converge in distribution to a zero mean multivariate Gaussian. This is reasonable due to the randomization and the large sample used in experiments [Casella and Berger, 2021, Deng et al., 2018].

### Theoretical Results

Following the assumptions above, the following theoretical result can be derived, which shows that given the assumptions described in the previous section, the pairs estimator \hat{Δ}^{Pairs}(M, T) will effectively reduce estimation variance compared to the naive estimator, \hat{Δ}(M, T).

### Variance Reduction Effect of the Pairs Estimator

With the assumptions stated above, it can be shown that the IPW estimators, \hat{Δ}^{IPW}(T) and \hat{Δ}_{M}^{IPW}(T) can be decomposed as \hat{δ}^{IPW}(T)=\hat{δ}+f(B), \hat{δ}_{M}^{IPW}(T)=\hat{δ}_{M}+f(B)+g(v, B), where f and g are random variables that depend on B (or also v), and g(v, B) is orthogonal to \hat{δ}, \hat{δ}_{M} and f(B). Furthermore, if the estimation error of model quality estimators is defined as follows:

$$e ( {\hat{Δ}}^{Pairs} ( M , T ) ) := {\hat{Δ}}^{Pairs} ( M , T ) - Δ ( M ) ,$$

$$e ( \hat{Δ} ( M , T ) ) := \hat{Δ} ( M , T ) - Δ ( M ) ,$$

then both \sqrt{N}e(\hat{Δ}^{Pairs}(M, T)) and \sqrt{N}e(\hat{Δ}(M, T)) are asymptotically normal with zero means, and their variances satisfy

[symbol]

ar[e(\hat{Δ}^{Pairs}(M, T))]< [symbol] ar[e(\hat{Δ}(M, T)]

See below for the proof.

This result provides theoretical justifications that the simple estimator provided herein is effective for variance reduction.

### Simulation Studies

In this section, the performance of the proposed pairs estimator is evaluated, and the theoretical insights validated via simulation studies. The robustness and sensitivity of the pairs estimator concerning different scenarios of non-randomized trials is also shown, including treatment assignment mechanisms, degree of imbalance, choice of causal machine learning models, etc.

### Synthetic csuite Dataset With Hypothetical Causal Model

Following Geffner et al. [2022], a set of synthetic datasets is constructed, designed specifically for evaluating causal inference performance, for example csuite datasets. The data-generating process is based on structural causal models (SCMs), different levels of confounding, heterogeneity, and noise types are incorporated, by varying the strength, direction, and parameterize of the causal effects. The performance was evaluated on three different datasets, namely csuite_1, csuite_2, and csuite_3, each with a different SCM. See below for more details. The corresponding causal model estimation is simulated using a special form of Assumption A, that is:

$${Y}_{M}^{T = t} ( i ) = {Y}^{T = t} ( i ) + {V}_{i} ( {Y}^{T = t} ( i ) ) * {v}_{i} , i = 1 , 2 , ... N , t ∈ \{ 0 , 1 \} ,$$

where vᵢ are i.i.d. distributed zero-mean random variables with variance σᵥ² that affects the ground truth causal error. To simulate the non-randomized trials, two different schemes are used to generate the treatment assignment plans T. The first scheme is based on a logistic regression model of the treatment assignment probability given the covariates, that is,

$${p}_{exp} ( T = 1 \vert X ) = \frac{1}{1 + exp ( - {β}^{T} X )} ,$$

where β is a random vector sampled from multivariate Gaussian distributions with mean zero and variance σ_{β}². The degree of imbalance in the treatment assignment is varied by changing the value of σ_{β}². A larger σ_{β}² implies a more imbalanced treatment assignment, as the variance of the treatment assignment probability increases. The second scheme is based on a random subsampling of the units, where the treatment assignment probability is fixed for each unit, but different units are sampled with replacement to form different treatment assignment plans. The number of treatment assignment plans is varied by changing the sample size of each subsample.

### Evaluation Method

The performance of the pairs estimator is compared with the naive estimator, as well as the RCT estimator, which is considered the benchmark for causal model evaluation. It is also compared with two other baselines, by replacing the IPW component \hat{δ}^{IPW}(T) in the naive estimator by its variance reduction variants. This includes the self-normalized estimator, as well as the linearly modified (LM) IPW estimator set out in Zhou and Jia [2021], a state-of-the-art method for IPW variance reduction when the propensity score is known. The performance of the estimators is measured by the following metrics: the variance, the bias, and the MSE of the causal error estimation. See below for detailed definitions. These metrics are computed by averaging over 100 different realizations of the treatment assignment plans for each dataset.

### Results

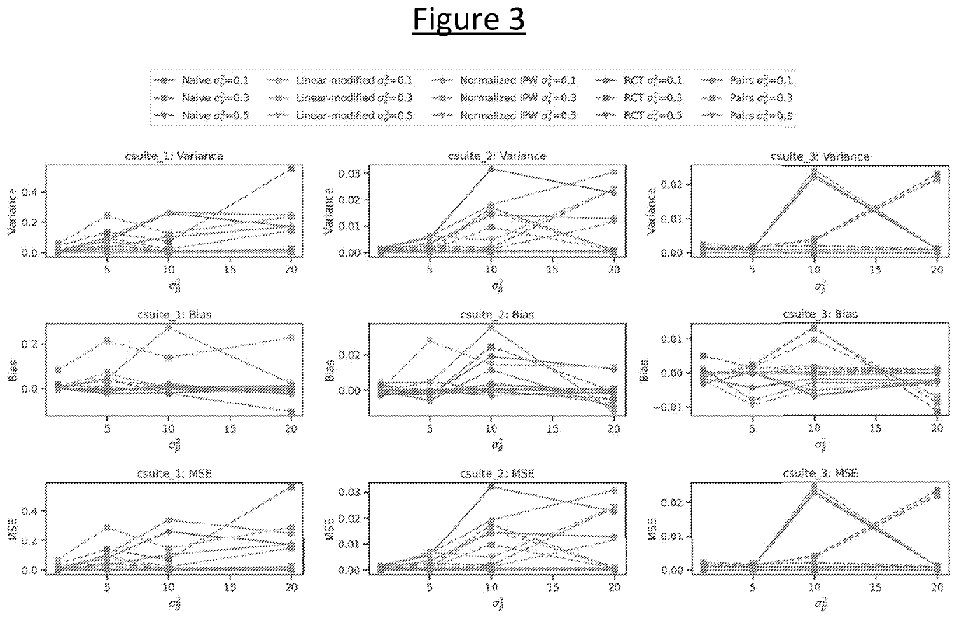

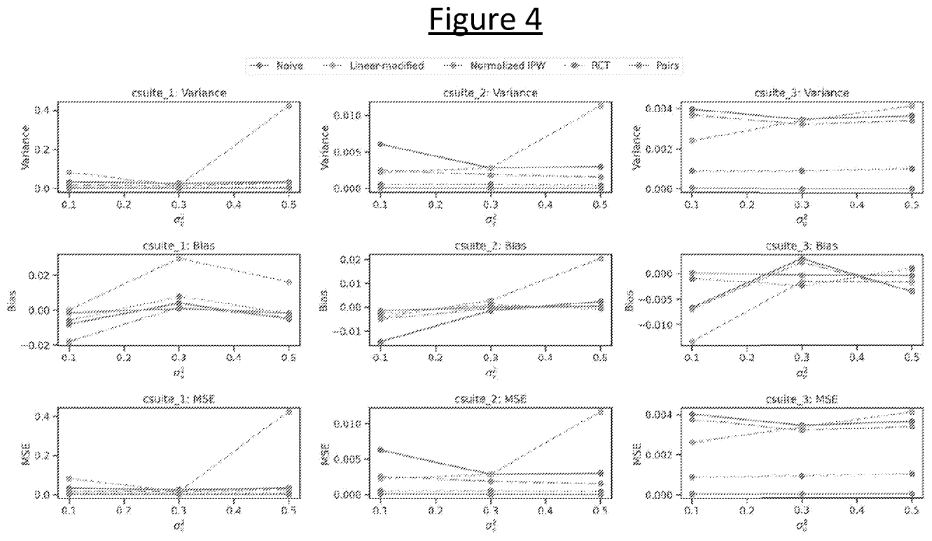

The results are shown in FIG. 3 and FIG. 4. FIG. 3 shows the results for the logistic regression scheme, with different values of σᵥ² and σ_{β}². FIG. 4 shows the results for the random subsampling scheme, with different σᵥ². In both tables, the average and the standard deviation of the performance metrics of the estimators for each value of the true causal error are shown, which is computed by the difference between the true treatment effect and the model treatment effect.

FIG. 3 provides a comparison of various causal error estimators for the logistic assignment scheme across (csuite_1, csuite_2, and csuite_3). In this 3×3 plot, each row corresponds to a specific performance metric (Variance/Bias/MSE), while each column represents different datasets. In each plot, the x-axis represents the degree of treatment assignment imbalance σ_{β}², while the y-axis displays the performance metrics (lower the better). The different colors indicate the performance of different estimators, and different linestyles and markers indicate different σᵥ² settings. The results demonstrate that the proposed estimator (purple) consistently outperforms the other estimators in terms of all performance metrics, with a more robust behavior as the imbalance in treatment assignment increases.

FIG. 4 provides a comparative analysis of multiple causal error estimators in the context of the random subsampling scheme for (csuite_1, csuite_2, and csuite_3). In each plot, the x-axis represents the variance of the noise variable (σᵥ²), and the y-axis illustrates the performance metrics (Variance/Bias/MSE) for each estimator. Different colors denote the performance of different estimators. The findings reveal that, under the random subsampling scheme, the proposed estimator (purple) also consistently surpasses other estimators in every performance metric.

From the data provided in FIGS. 3 and 4, it can be seen that the variance of the naive estimator quickly increases when the treatment assignment is highly imbalanced. Nevertheless, our estimator (purple) consistently outperforms the naive estimator and its variance reduction variants in all metrics (variance/bias/MSE) regardless of the value of σᵥ². and the degree of imbalance σ_{β}². The pairs estimator also achieves comparable performance to the RCT estimator, which is considered the golden standard by design in the art. The linearly-modified estimators and self-normalized estimators have a lower variance than the naive estimator, but it also introduces some bias, and their performance is sensitive to the degree of imbalance. These demonstrate the effectiveness and robustness of the pairs estimator provided herein when all assumptions are met.

### Synthetic Counterfactual Dataset With Popular Causal Inference Models

In this section, more realistic experimental settings are considered, in which a wide range of machine learning-based causal inference methods are applied by training them from synthetic observational data. Thus, the assumptions set out above might not strictly hold anymore, which can be used to test the robustness of the method. A wide range of methods are included, such as linear double machine learning [Chernozhukov et al., 2018] (referred to as DML Linear), kernel DML (DML Kernel) [Nie and Wager, 2021], causal random forest (Causal Forest) [Wager and Athey, 2018, Athey et al., 2019], linear doubly robust learning (DR Linear), forest doubly robust learning (DR Forest), orthogonal forest learning (Ortho Forest) [Oprescu et al., 2019], and doubly robust orthogonal forest (DR Ortho Forest). All methods are implemented via EconML package [Battocchi et al., 2019]. See below B for more details.

Two aspects are focused on: 1), whether the proposed estimator can still be effective on variance reduction with non-hypothetical models set out in the previous section; and 2), whether the learned causal models' counterfactual predictions approximately follow the postulated Assumption A. Here We present the results for the first aspect, and results for the second can be found later.

### Simulation Procedure

The same simulation procedure in the previous section is repeated using the learned causal inference models instead of the simulated causal model. The performance of the pairs estimator is compared with the same baselines previously, using the same metrics and the same treatment assignment schemes. For DML Linear, DML Kernel, Causal Forest, and Ortho Forest (that does not require propensity scores), the models are trained on 2000 observational data points generated via the following data generating process of single continuous treatment [Battocchi et al., 2019]:

$$W ∼ Normal ( 0 , {I}^{{n}_{w}} ) , X ∼ {Uniform ( 0 , 1 )}^{{n}_{x}} \\ T = 〈 W , β 〉 + η , Y = T \cdot θ ( X ) + 〈 W , γ 〉 + ϵ ,$$

where T is the treatment, W is the confounder, X is the control variable, Y is the effect variable, and η and ϵ are some uniform distributed noise. The dimensionality of X and W is chosen to be nₓ=30 and n_{w}=30, respectively. For other doubly robust-based methods, a discrete treatment is used that is sampled from a binary distribution P(T=1)=sigmoid( [symbol] W, β [symbol] +η), while keeping the others unchanged. Once models are trained on the generated observational datasets, the trained causal inference model are used to estimate the potential outcomes and the treatment effects for each unit. Then, the logistic regression-based treatment assignment scheme as in the previous section is used to simulate a hypothetical non-randomized experiment (for both continuous treatment and binary treatment, T=1 for the treatment group and T=0 for the control group). Both the pairs estimator and the other baselines presented in the previous section are used to estimate the causal error. This is repeated 100 times across 3 different settings for treatment assignment imbalance (σ_{β}²=1, 5, 10).

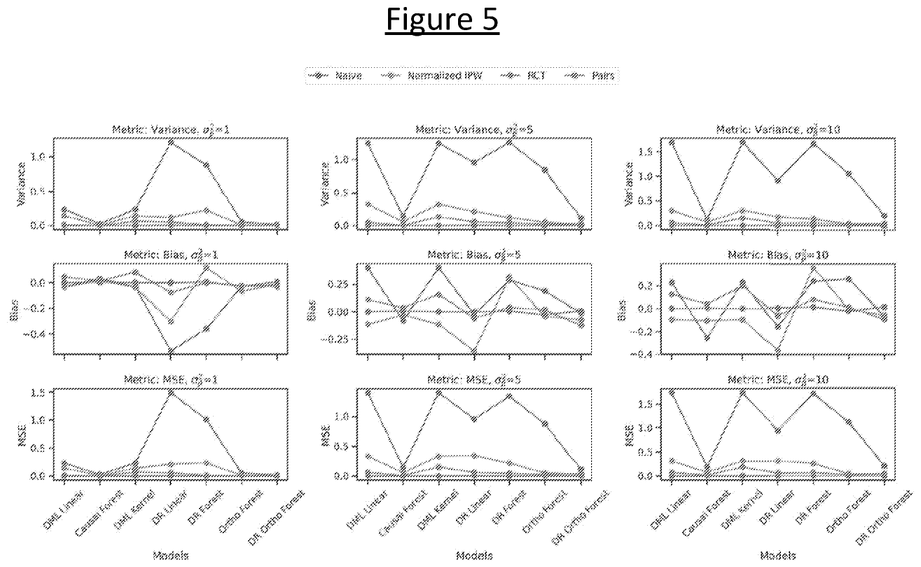

FIG. 5 shows the performance of different causal error estimators across different causal inference methods. Each row of the grid corresponds to a specific performance metric (Variance/Bias/MSE), while each column represents different levels of treatment assignment imbalance (σ_{β}²). In each plot, the x-axis represents different causal models. The y-axis displays performance metrics. Different colors correspond to different estimators. The results highlight the differences in performance among the estimators, with the pairs estimator (purple) consistently outperforming others in most scenarios, emphasizing its robustness and effectiveness in assessing various causal models. The linearly-modified baseline is not displayed for clarity reasons.

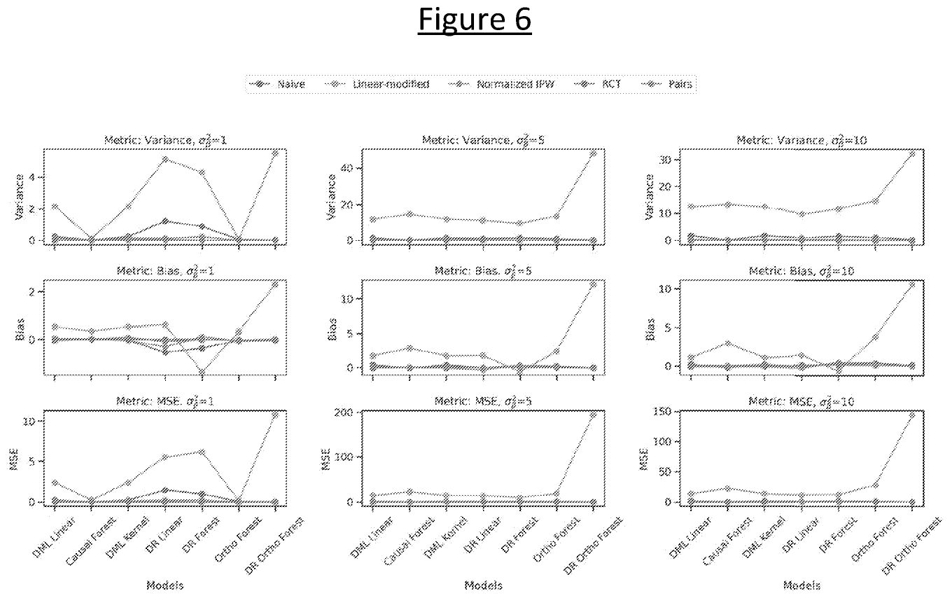

FIG. 6 shows causal error estimator quality metrics for across common causal methods (full results including linearly-modified IPW). Each row of the grid corresponds to a specific performance metric (Variance/Bias/MSE), while each column represents different levels of treatment assignment imbalance (σ_{β}²). In each plot, the x-axis represents different causal models. The y-axis displays performance metrics. Different colors correspond to different estimators.

### Results

FIG. 5 shows that using the estimator with non-RCT data, near-RCT performance for causal model evaluation quality across all metrics is achieved. It is also more robust to different settings of σ_{β}², where no significant variance change is observed. It is also seen that each causal error estimator has a different sweet-spot: for instance, the naive estimator usually consistently works very well with Causal Forest, whereas our estimator has relatively high variance and bias for DML Kernel. Nevertheless, the proposed estimator is still the most robust estimator (apart from RCT) that consistently achieves the best results across all causal models. This shows the feasibility of our method for reliable model evaluation with non-RCT experiments.

### Conclusions

The above pairs estimator is a novel methodology for low-variance estimation of causal error in non-randomized trials. This approach applies the same IPW method to both the model and ground truth effects, cancelling out the variance due to IPW. Remarkably, the pairs estimator can achieve near-RCT performance using non-RCT experiments, signifying a novel contribution for enabling more reliable and accessible model evaluation, without depending on expensive or infeasible randomized experiments. The method provided herein may be applied to more complex scenarios, for alternative ways to reduce causal error estimation variance, and to other causality applications such as policy evaluation, causal discovery, and counterfactual analysis.

### Example Causal Models

Below are described various examples of causal models to which the causal error estimation is applicable.

One example of a causal inference model is the propensity score matching method, to which the causal error estimation mechanism may be applied.

A propensity score matching method may be trained by: receiving a training dataset specific to a domain, the training dataset comprising a covariate matrix and a treatment vector, the training dataset obtained by selectively performing treatment actions on at least one physical system; training a propensity score model using the training dataset, resulting in a trained propensity score model.

An estimation of treatment effect may be generated using the propensity score matching method by: computing propensity scores for each unit in the dataset using the trained propensity score model; matching treated and control units based on their propensity scores; estimating the causal effect associated with the treatment vector based on the matched pairs of treated and control units; based on the causal effect, determining a further treatment action; and performing the treatment action on the physical system.

Propensity scores are known in the art, and therefore will not be described in detail herein. In summary, a propensity score is the probability of an input being assigned to a particular treatment given a set of observed covariates. Propensity scores are used to reduce confounding by equating groups based on these covariates.

Another example of a causal inference model is a difference-in-differences (DID) method, which can also be applied with the causal error estimation mechanism.

A DID method may be trained by: receiving a training dataset specific to a domain, the training dataset comprising a covariate matrix, a treatment vector, and an outcome vector, the training dataset obtained by selectively performing treatment actions on at least one physical system before and after a specific intervention.

An estimation of treatment effect may be generated using the DID method by: computing a difference in average outcome between treatment and control groups before and after the specific intervention in the dataset; estimating a causal effect associated with the treatment vector based on the difference; based on the causal effect, determining a further treatment action; and performing the treatment action on the physical system.

A third example of a causal inference model is an outcome modelling method, which can also be applied with the causal error estimation mechanism.

The outcome modelling method may be trained by: receiving a training dataset specific to a domain, the training dataset comprising a covariate matrix, a treatment vector, and an outcome vector, the training dataset obtained by selectively performing treatment actions on at least one physical system; training an outcome model using the training dataset, resulting in a trained outcome model.

An estimation of treatment effect may be generated using the outcome modelling method by: applying the trained outcome model to the dataset; estimating a causal effect associated with the treatment vector based on the predicted outcomes generated by the trained outcome model; based on the causal effect, determining a further treatment action; and performing the treatment action on the physical system.

The outcome modelling method may involve various regression techniques, such as linear regression, logistic regression, or machine learning algorithms like decision trees, support vector machines, and neural networks, to model the relationship between the treatment vector, covariate matrix, and outcome vector. By leveraging these techniques, the method can estimate causal effect of the treatment on the outcome while accounting for the influence of the covariates.

Another example of a causal inference model (referred to herein as a causal foundational model) is described, to which the causal error estimation mechanism may be applied.

The causal inference model may be trained by: receiving a first training dataset specific to a first domain, the first training dataset comprising a first covariate matrix and a first treatment vector, the first training dataset obtained by selectively performing first treatment actions on at least one first physical system; receiving a second training dataset specific to a second domain, the second training dataset comprising a second covariate matrix and a second treatment vector, the second dataset obtained by selectively performing second treatment actions on at least one second physical system; training using the first training dataset and the second training dataset a causal inference model based on a training loss that quantifies error between each treatment vector and a corresponding forward mode output computed by the causal inference model, resulting in a trained causal inference model.

An estimation of treatment effect may be generated using the causal foundational model by: computing a rebalancing weight vector using the trained causal inference model applied to a third dataset specific to a third domain, the third dataset comprising a third covariate matrix, a third treatment vector and a third outcome vector, the third dataset obtained by selectively performing third treatment actions on a third physical system; estimating based on the third outcome vector and the rebalancing weight vector a causal effect associated with the third treatment vector; based on the causal effect, determining a further treatment action; and performing the first treatment action on at least one target physical system belonging to the third domain.

The third dataset may be specific to a third domain, and it may be that the causal inference model is not exposed to any data from the third domain during training.

The second training dataset and the third dataset may each be non-randomized.

The at least one third system may comprise the at least one target physical system.

The causal inference model may generate during training: a first output value, wherein the forward mode output corresponding to the first training dataset is computed based on the first output value and a first normalization factor computed from the first covariate matrix, and a second output value, wherein the forward mode output corresponding to the second training dataset is computed based on the second output value and a second normalization factor computed from the first second matrix. The rebalancing weight vector may be computed based on: a third output value computed by the trained causal inference model, the third treatment vector, and a third renormalization factor computed from the third covariate matrix.

Alternatively or additionally the causal error estimation mechanism may be applied to one or more known causal models.

When the causal error estimation mechanism is applied to multiple trained causal models, a respective treatment error is calculated for each of the models. Based on these calculated treatment errors, one of the trained causal models is selected. The treatment action which is selected, and subsequently applied to the physical system, is determined using the selected one of the trained causal models.

### Example Causal Foundational Model

Foundation models such as language foundation models (e.g., large language models, such as generative pre-trained transformers (GPT) models) and image foundation models (e.g., DALL-E) have been built. However, in contrast to existing foundational models, a foundational paradigm is provided herein for building general-purpose machine learning systems for causal analysis, in which a single model trained on a large amount of unlabelled data can be adapted to many/arbitrary applications in causal inference. In other words, a single machine model is built that, once trained, can be directly used in any domain for any problem that can be characterized as “estimating effects of certain actions from data”. It can be instantly used in manufacturing industry, scientific discovery, medical research, aerospace industry etc. with none or little adjustment. The approach herein not only yields a significant saving in costs and resources compared to a conventional approach, which would require development of solutions in those scenarios specifically, but does so while achieving similar or even better performance.

Conventional foundation models such as language foundation models and image foundation models may be powerful in terms of generating vivid images and human-like conversations, but they are not “causally-aware”, meaning that they cannot be used to estimate the underlying causal effects. Therefore, they are mostly purely “brute force algorithms” which makes them prone to issues such as hallucinations (generating plausible but incorrect outputs). On the contrary, embodiments herein provide a “causally-aware” foundation model that, despite being trained on non-experimental observational data, can still identify and quantify underlying causal effects without requiring of performing additional A/B experiments or expert knowledge. The causal foundational model can even on another task/domain which it has not encountered in training.

An analysis is described herein, which motivates a concrete transformer architecture that can be exactly mapped to solutions of a Riesz representator learning (RR) problem. Those RR solutions can be directly used to perform causal inference with only non-experimental observational data. One example of such RR problem is the classical support vector machine (SVM) learning problem. In other words, to implement our causal foundational model, we train a transformer to serve as a one-shot solver for any Riesz representator problems. Once trained, given observational data from any task or domain, it will directly predict the solutions of Riesz representator problem (without actually having to incur the computational expense of solving it), and use the predicted solutions to estimate the causal effects or any decision queries.

One such approach described herein may be used to estimate casual effect from imperfect, non-randomized datasets. The described approach can recognize and correct bias in any treatment dataset with N units of the form [symbol] ={(Xᵢ, Tᵢ, Yᵢ)}_{i∈[N]}, where Xᵢ denotes a set of D observed covariates (where D is one or more) of the i^{th} unit, Tᵢ denotes a treatment observation for the i^{th} unit (e.g. an indication of whether or not a given treatment was applied to that unit), and Yᵢ denotes an outcome observed in respect of the i^{th} unit. In the following X denotes an N×D matrix of covariates across the N units, T denotes an N-dimensional treatment vectors containing the treatment observations across the N units and Y denotes an N-dimensional vector of the N observed outcomes.

A ‘covariate balancing’ mechanism is used to account for biases exhibited in a dataset of the above form. Balancing weights are calculated and applied to the dataset, in order to reduce confounder bias, and thereby enable a more accurate estimation of casual treatment effect (that is, truly causal relationships between treatments and outcomes, as opposed to mere correlations between treatments and outcomes exhibited in the dataset). This, in turn, reduces the risk of selecting and applying sub-optimal treatments in the real-world.

In the described approach, a neural network is trained to generate a set of balancing weights α from a set of inputs. Whilst a neural network is described, the description applied equally to other forms of machine learning components. At inference, balancing weights α computed from a given dataset may then be used to rebalance the outcomes as αY.

A novel training mechanism is described herein, in which a neural network is trained on a covariate re-balancing task in a self-supervised manner, using large amounts of “unlabelled’ training data pertaining to many different domains (e.g., fields, applications and use cases). Rather than approaching casual inference as a domain-specific task (e.g. designing one causal-inference approach for a particular manufacturing application, another for a particular aerospace application, another for a specific medical application etc.,) a general-purpose causal inference mechanism is learned from a large, diverse training set that contains many treatments dataset over many field/applications (e.g. combining manufacturing data, engineering data, medical data etc. in a single dataset used to train a single neural network). In other words, a cross-domain causal inference model is trained, which can then be applied to treatment dataset in any domain (including domains that were not explicitly encountered by the neural network during training).

In one approach, the balancing weights are generated from X and T provided as inputs to the neural network. In this approach, outcomes Y are not required to generate the balancing weights α. This, in turn, means it is not necessary to expose the neural network to outcomes during training. and it is therefore possible to train the neural network on datasets of the form {{X, T}ⱼ}, implying that the covariates are known and the assignment to treatment groups is known, but the outcomes may or may not be known). Here, the index j denotes the j^{th} dataset belonging to the training set, where j=1 might for example be an engineering dataset, j=2 might be a manufacturing dataset, j=3 might be a medical dataset etc. The neural network may be conveniently denoted as a function f_{θ}(X, T) where θ denotes parameters (such as weights) of the neural network that are learned in training. In the described architecture, the neural network returns an N-dimensional vector V as output—that is, f_{θ}(X, T)=V− and rebalancing weights are computed from V as VT/Z

$$( implying {α}_{i} = \frac{{V}_{i} {T}_{i}}{{Z}_{i}} ) ,$$

where Z=h(X) is a renormalization factor computed as a function of the covariates X computed within the neural network. The parameters θ are learned in a self-supervised manner, from X and T alone (and, in this sense the training set {{X, T}ⱼ} is said to be unlabelled).

The neural network may be a “large” model, also referred to as a “foundational” model. Large models have typically of the order a billion parameters or more, trained on vast datasets. In the present context, a “causal foundational model” may be trained using the techniques described herein to be able to rebalance any treatment dataset, including treatment datasets relating to contexts, applications, fields etc that were not encountered during training.

Training on examples of {X, T}, without outcomes Y is viable because the training is constructed in a manner that causes the neural network to consider all possible outcomes, and minimize worst case scenario. This property makes the neural net generalizable and robust to any scenarios.

In another embodiments, outcome Y may be additionally incorporated into the training process. In this case, Y is also provided as input to the neural network. If the model is trained on synthetic and/or real datasets where treatment effects (ATE) are known, then the 15 treatment effects ATE may be used as ground truth to compute a supervised signal. In other words, the training dataset now becomes D={(X, T, Y, ATE)}. During training, the neural network uses both a forward model and a test mode to produce both predictions for treatment vector and the ATEs, and an error is minimized for both the treatment vector (T) and the ATE.

In embodiments, a computer-implemented training method comprises training, refining, and accessing a machine learning (ML) causal inference model (such as a large ML model). The causal inference model can learn to solve arbitrary casual inference problems and decision-making problems using observational data from multiple (any) domains. Once trained on multiple data sources, the causal inference model is able to generalize to solve any tasks beyond training data. That is, the user may input a new data set, comprising observational records of any system of interest (in any domain); then the model can estimate a causal treatment effect of a selected treatment variable on any target variables. Based on the estimated causal effects, a system incorporating the causal inference model can recommend optimal actions to achieve optimal outcomes, or even perform such actions (or cause them to be performed) autonomously.

The model is trained on a set of multiple datasets (a training dataset of datasets), denoted by D₁, D₂, . . . , D_{L}, in so-called “forward” mode, with the goal of being able to simulate realistic synthetic samples that are as close to the provided multiple datasets as possible. To fully describe the logics, each dataset Dᵢ(1≤i≤L) may comprise three tables, namely the covariates Xᵢ (a table of size N by D, N and D might defer from datasets), the treatments Tᵢ (a table of size N by 1), and the target Yᵢ (a table of size N by 1). However, as noted, the outcomes Y are not essential for training.

In training, the causal inference model learns a row-wise embedding, that maps the covariates Xᵢ and treatments Lᵢ of each dataset Dᵢ to an embedding Eᵢ (of size N by M, where M is the embedding size) that summarizes the row-wise information of the dataset. This embedding is called row-wise, since each row of Eᵢ only depend on each row of the covariates Xᵢ and treatments Lᵢ. In practice, such embedding is implemented by a neural network.

On top of the row-wise embedding Eᵢ, the causal inference model learns a dataset-wise embedding, that maps Eᵢ of each dataset Dᵢ to a vector Vᵢ of size N by 1. Vᵢ, namely the value vector, will summarize the causal information of the entire dataset Dᵢ. In practice, such embedding may be implemented by a self-attention neural network module, followed by an ReLu activation function mapping and an element-wise multiplication with the treatment vector, Tᵢ.

For each dataset Dᵢ, the causal inference model simulates a forward mode output of the model, denoted by Fᵢ, a vector of size N by 1, which is given by the matrix multiplication between a softmax-kernel of Xᵢ, and the value vector Vᵢ.

Finally, the causal inference model is trained with the goal of driving the simulated forward mode outputs Fᵢ to be as close to the real observed treatment vectors Tᵢ in every single said datasets D₁, D₂, . . . , D_{L} as possible.

After training, the causal inference model may be used to estimate a target variable from among the variables of any given new dataset D* comprising N* data points, usually unseen by the model during training. This process involves estimating, given covariates X* and treatments T* of a new dataset D*, a corresponding value vector V*, using forward mode. Causal balancing weights α*, a of size N* by 1, are generated by first multiplying V* by T*, then renormalizing the values with a certain renormalization factor, Z*. A causal treatment effect of the variable T* on Y* is calculated by first multiplying the balancing weights α*, treatments T*, and targets Y*, and then finally summing up all the values obtained in the said multiplication.

The causal inference model may, for example, be implemented using a transformer architecture, with a self-attention layer, or other attention-based architecture. Until recently, state of the art performance has been achieved in various applications with relatively mature neural network architectures, such as convolutional neural networks. However, newer architectures, such as “transformers”, are beginning to surpass the performance of more traditional architectures in a range of applications (such as computer vision and natural language processing). Encoder-decoder neural networks, such as transformers, have been developed based solely or primarily on “attention mechanisms”, removing or reducing the need for more complex convolutional and recurrent architectures.

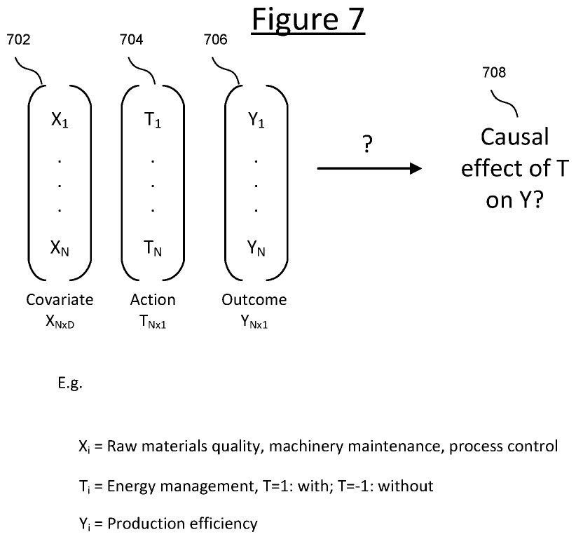

The approach summarized above is visualized, and contrasted with conventional causal inference techniques, in FIGS. 7 to 13, which show series of computational graphs.

FIG. 7 provides an overview of causal inference. Three vectors are provided as inputs: a covariate matrix X_{N×D} 702, an action vector T_{N×1} 704, and an outcome vector Y_{N×1} 706. Taking an example use case of improving efficiency in manufacturing, the items Xᵢ of the covariate matrix 702 may be raw material quality, machine maintenance values, and process controls, the items Tᵢ of the of the action vector 704 may be energy management, where T=1 if there is energy management and T=−1 if there is no energy management, and the items Yᵢ of the outcome vector 706 represent production efficiency. Based on these inputs, the causal effect 708 of the actions on the outcome can be determines, that is the causal effect of T_{N×1} on Y_{N×1}.

The covariate matrix X_{N×D} 702, an action vector T_{N×1} 704, and an outcome vector Y_{N×1} 706 form the dataset 204 described above. FIG. 7 therefore represents the step of determining the model estimation of treatment effect to which IPW is applied in the method of FIG. 2.

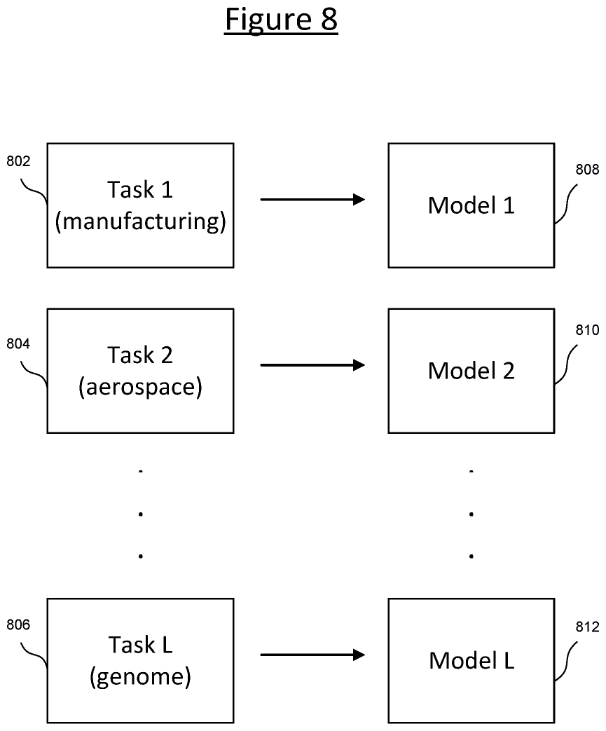

Conventional, domain-specific causal inference approaches may be summarized as shown in FIG. 8. In traditional causal inference, a given task has a specifically trained model, which is used to determine the causal effect of actions on the outcomes. For example, a first model 808 is trained on training data for manufacturing 802, and used for determining causal effects in manufacturing. A second, different, model 810 is trained on data associated with, and used for, aerospace 804, while a third model 812 is for trained on a dataset for Genomes 806.

In this alternative, domain-specific approach, domain-specific causal inference models may be separately trained (e.g. to perform domain-specific covariate rebalancing). However, this approach lacks flexibility, resulting in models that cannot be applied to domains that have not been explicitly trained on, and also model inefficiency, as multiple models need to be trained an implemented, requiring an amount of computing and memory/storage resources that increases with number of domains of interest and the number of domain specific models.

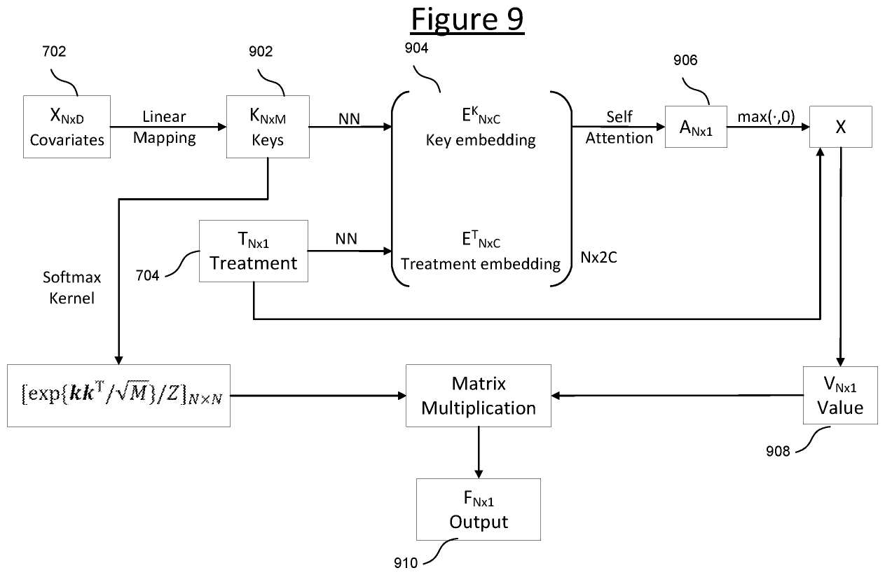

By contrast, one ‘general-purpose’ causal inference approach described herein may be summarized with reference to FIGS. 9 to 13. The methods set out in FIGS. 9 to 13 are summarised here and described in more detail later.

FIG. 9 illustrates a forward mode (training).

The covariate matrix X_{N×D} 702 is linearly mapped to a keys vector K_{N×M} 902. The keys vector K_{N×D} 902 and a treatment vector T_{N×1} 704 are both passed independently by a neural network to obtain an embedding vector 904, comprising a key embedding vector portion E_{N×C}^{K} and a treatment embedding vector portion E_{N×C}^{T}. Self-attention is applied to the embedding matrix 904 to obtain a vector A_{N×1} 906 and a max function applied, such that the resultant vector can be multiplied by the treatment vector T_{N×1} 704 to obtain a value vector V_{N×1} 908.

In parallel, a SoftMax kernel is applied to the keys vector K_{N×M} 902 to obtain a function [exp(KK^{T}/\sqrt{M})/Z]_{N×N}, which is multiplied with the value vector V_{N×1} 908 to obtain the output vector F_{N×1} 910.

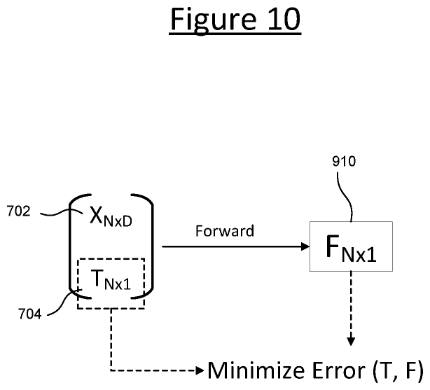

FIG. 10 illustrates training using a single data set, wherein the input matrix comprises the covariate matrix 702 and the treatment vector 704 to obtain the output vector F_{N×1} 910. A minimise error function is applied to the treatment and output vectors 704, 910.

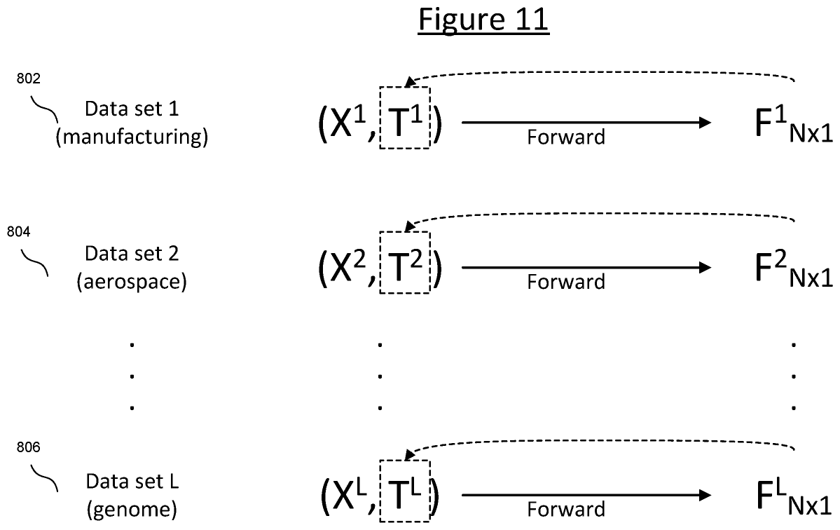

FIG. 11 illustrates training using multiple data sets 802, 804, 806, wherein each data set corresponds to a different domain.

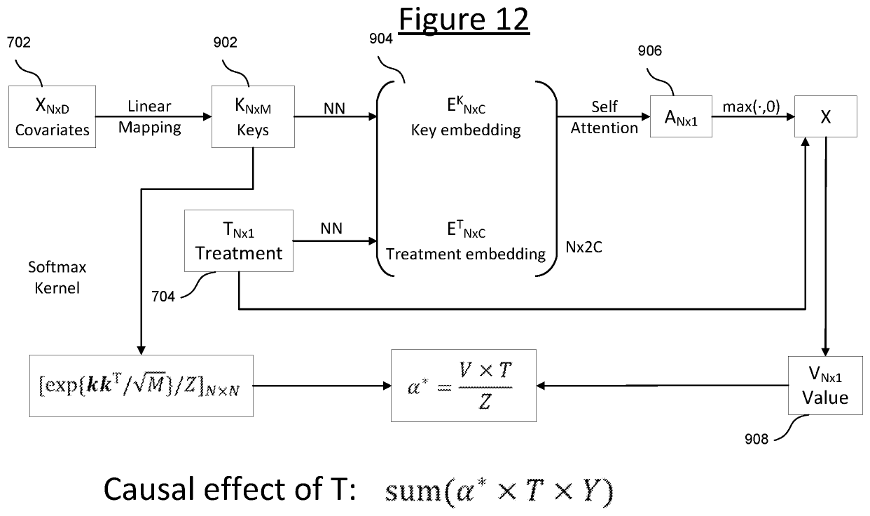

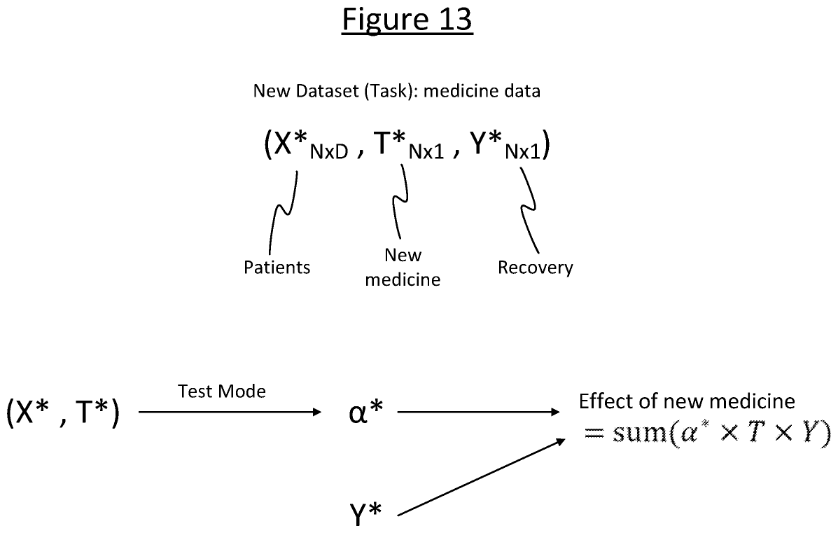

Rebalancing may be performed at test time/inference using the trained causal inference model, as illustrated in FIG. 12, with FIG. 13 illustrating the inference time.

The method of FIG. 12 differs from that of FIG. 9 in that optimal weights

$${α}^{*} = \frac{V \times T}{Z}$$

are computed from the outputs of the function [exp(KK^{T}/\sqrt{M})/Z]_{N×N} and the value vector V_{N×1} 908. The causal model estimation of the treatment effect is given as sum (α*×T×Y).

Algorithmically, the approach described above may be implemented as follows.

Attention-based neural networks are a powerful tool for ‘general-purpose’ machine learning. Attention mechanisms were historically used in ‘sequence2sequence’ networks (such as Recurrent Neural Networks). Such networks receive sequenced inputs and process those inputs sequentially. Historically, such networks were mainly used in natural language processing (NLP), such as text processing or text generation. Attention mechanisms were developed to address the ‘forgetfulness’ problem in such networks (the tendency of such network to forget relevant context from earlier parts of a sequence as the sequence is processed; as a consequence, in a situation where an earlier part of the sequence is relevant to a later part, the performance of such networks tends to worsen as the distance between the earlier part and the later part increases). More recently, encoder-decoder neural networks, such as transformers, have been developed based solely or primarily on attention mechanisms, removing or reducing the need for more complex convolutional and recurrent architectures.

A neural attention function is applied to a query vector q and a set of key-value pairs. Each key-value pair is formed of a key vector kᵢ and a value vector vᵢ, and the set of key-value pairs is denoted {kᵢ, vᵢ}. An attention score for the i^{th} key-value pair with respect to the query vector q is computed as a softmax of a dot product of the query vector with the i^{th} key value, q·kᵢ. An output is computed as a weighted sum of the value vectors, {vᵢ}, weighted by the attention scores.

For example, in a self-attention attention layer of a transformer, query, key and value vectors are all derived from an input sequence (inputted to a self-attention layer) through matrix multiplication. The input sequence comprises multiple input vectors at respective sequence positions, and may be an input to the transformer (e.g., tokenized and embedded text, image, audio etc.) or a ‘hidden’ input from another layer in the transformer. For each input vector xⱼ in the input sequence, a query vector qⱼ, a key vector kⱼ and a value vector vⱼ are computed through matrix multiplication of the input vector xⱼ with learnable matrices W^{Q}, W^{V}, W^{K}. An attention score α_{i,j} for every input vector xᵢ with respect to position j (including i=j) is given by the softmax of qⱼ·kⱼ. An output vector yⱼ for token j is computed as a weighted sum of the values v₁, v₂, . . . , weighted by their attention scores: yⱼ=Σᵢr_{i,j}vᵢ. The attention score r_{i,j} captures the relevance (or relative importance) of input vector xⱼ to input vector xᵢ. Whilst the preceding example considers self-attention, similar mechanisms can be used to implement other attention mechanisms in neural networks, such as cross-attention.

The ‘query-key-value’ terminology reflects parallels with a data retrieval mechanism, in which a query is matched with a key to return a corresponding value. As noted above, in traditional neural attention, the query is represented by a single embedding vector. In this context, an attention layer is, in effect, querying knowledge that is captured implicitly (in a non-interpretable, non-verifiable and non-correctable manner) in the weights of the neural network itself.

The methods for building causal foundational models outlined above will now be described in more detail. The method learns how to estimate treatment effects on multiple datasets in an end-to-end fashion. This procedure is powerful in its flexibility to incorporate different architectures and generalize to perform direct inference on new unseen datasets.

Balancing covariates is used as a self-supervised task to learn treatment effects on multiple heterogenous datasets that may have arisen from various sources. By using the connection between optimal balancing and self-attention, optimal balancing can be solved via training models with self-attention as the last layer.

It is shown that this procedure is guaranteed to find the optimal balancing weights on a single dataset under certain regularities, by using a primal-dual argument.

This approach can generalize well to out of distribution datasets and various different real-world datasets, reaching and even out-performing traditional per dataset causal inference approaches.

### Duality Between Causality and Self-Attention an Adversarial Optimal Framework for Causal Inference

Sample average treatment effects are estimated to illustrate the method provided herein. This is later extended to other estimands, such as those for sample average treatment effect of the treated, policy evaluation, and etc. Consider a dataset of N units in the form of D={(Xᵢ, Tᵢ, Yᵢ)}_{i∈[N]}, where Xᵢ is the observed covariates, Tᵢ is the observed treatment, and Yᵢ is the observed outcome. Suppose Tᵢ∈{0, 1} for now. Let Yᵢ(t) be the potential outcome of assigning treatment Tᵢ=t. The sample average treatment effect is defined as

$${τ}_{S A T E} = \frac{1}{N} {\sum }_{i = 1} {Y}_{i} ( 1 ) - {Y}_{i} ( 0 ) .$$

Assume Yᵢ=Yᵢ(Tᵢ), i.e., consistency between observed and potential outcomes and non-interference between units (Rubin, 1990), and Yᵢ(0), Yᵢ(1)⊥Tᵢ|Xᵢ, i.e., no latent confounders. Weighted estimators in the form of

$$\hat{τ} = {\sum }_{i ∈ 𝕋} {α}_{i} {Y}_{i} ( 1 ) - {\sum }_{i ∈ ℂ} {α}_{i} {Y}_{i} ( 0 ) ,$$

are considered, where [symbol] ={i∈[N]: Tᵢ=1} is the treated group and [symbol] ={i∈[N]: Tᵢ=0} is the control group.

Constraints are forced on the weight by allowing α∈ [symbol] ={0 [symbol] α [symbol] 1, [symbol] αᵢ= [symbol] αᵢ=1}. These constraints help with maintaining robust estimators. For example, [symbol] αᵢ=1 ensures that the bias remains unchanged if we add a constant to the outcome model of the treated, whereas [symbol] αᵢ=1 further ensures that the bias remains unchanged if the same constant is added to the outcome model of the control.

A good estimator should minimize the absolute value of the conditional bias that can be written as:

$$𝔼 [ \hat{τ} - {τ}_{S A T E} \vert {\{ {X}_{i} , {T}_{i} \}}_{i = 1}^{N} ] = {\sum }_{i = 1}^{N} ( {α}_{i} {T}_{i} - \frac{1}{N} ) 𝔼 ( {Y}_{i} ( 1 ) - {Y}_{i} ( 0 ) \vert {X}_{i} ) + {\sum }_{i = 1}^{N} {α}_{i} {W}_{i} 𝔼 ( {Y}_{i} ( 0 ) \vert {X}_{i} ) , \\ where {W}_{i} = 1 if i ∈ 𝕋 and {W}_{i} = - 1 if i ∈ ℂ .$$

As the outcome models are typically unknown, previous works (Tarr & Imai, 2021: Kallus, 2020) are followed by minimizing an upper bound of the square of the second term. Namely, assuming the outcome model [symbol] (Yᵢ(0)|Xᵢ) belongs to a hypothesis class [symbol] , the solution to [symbol] [symbol] (Σᵢ₌₁^{N}αᵢWᵢf(Xᵢ))² is found. To simplify this, consider [symbol] being a unit ball in a reproducing kernel Hilbert space (RKHS) defined by some feature map ϕ. Then the supremum can be computed in closed form, which reduces the optimization problem to

$${min}_{α ∈ A} {α}^{T} {K}_{ϕ} α , {where [ {K}_{ϕ} ]}_{i , j} = {W}_{i} {W}_{j} {ϕ ( {X}_{i} )}^{T} ϕ ( {X}_{j} ) . \qquad ( 1 )$$

This equation is equivalent to a dual SVM problem, discussed later.

The method provided herein can generalize to alternative balancing objectives, e.g., the square of both terms in the conditional bias and the conditional mean square error.

### Causal Inference as Dual SVM and Support Vector Expansions

In order to learn the optimal balancing weights via training an attention network, one key idea is to re-derive the optimization problem above as a dual SVM problem. Suppose we classify the treatment assignment Wᵢ based on feature vector ϕ(Xᵢ) via SVM, by solving the following optimization problem,

$${min}_{β , {β}_{0} , ξ} \frac{λ}{2} {‖ β ‖}^{2} + {\sum }_{i = 1}^{N} {ξ}_{i} , s . t . {W}_{i} 〈 β , ϕ ( {X}_{i} ) 〉 + {β}_{0} \geq 1 - {ξ}_{i} , {ξ}_{i} \geq 0 , ∀ i ∈ [ N ] . \qquad ( 2 )$$

Here [symbol] ⋅,⋅ [symbol] denotes the inner product of the Hilbert space to which ϕ projects. The dual form of this problem corresponds to

$${min}_{α} {α}^{T} {K}_{ϕ} α - 2 λ \cdot {1}^{T} α s . t . {W}^{T} α = 0 , 0 ≼ α ≼ 1. \qquad ( 3 )$$

This is equivalent to solving Equation (1) for some λ≥0 (Theorem 1 in Tarr & Imai (2021)); in other words, the optimal solution α* to Equation (3) solves Equation (1). Thus we can obtain the optimal balancing weight by solving the dual SVM.

Another useful result is the support vector expansion of the optimal SVM classifier, which connects the primal solution to the dual coefficients α*. By the KKT condition (Boyd & Vandenberghe, 2004), the optimal β* that solves Eq. (2) should satisfy β*=Σᵢ₌₁^{N}α*ⱼWⱼϕ(Xᵢ). Thus, the optimal classifier will have the following support vector expansion:

$$〈 {β}^{*} , ϕ ( {X}_{i} ) 〉 = {\sum }_{j = 1}^{N} {α}_{j}^{*} {W}_{j} \cdot 〈 ϕ ( {X}_{j} ) , ϕ ( {X}_{i} ) 〉 . \qquad ( 4 )$$

Note that the constant intercept is dropped for simplicity. In the next subsection, the self-attention layer is written in this form.

### Self Attention as Casual Support Vector Expansion

Consider input sequence as X=[X₁, X₂, . . . X_{N}]^{T}∈ [symbol] ^{N×D}^{_{X}}. A self-attention layer transforms X into an output sequence via

$$softmax ( \frac{Q {K}^{T}}{\sqrt{D}} ) V , \\ where Q = {[ {q}_{1} , … {q}_{N} ]}^{T} ∈ {ℝ}^{N \times D} , K = {[ {k}_{1} , … {k}_{N} ]}^{T} ∈ {ℝ}^{N \times D} , and V = {[ {v}_{1} , … {v}_{N} ]}^{T} ∈ {ℝ}^{N \times 1} .$$

Here the output is considered as a sequence of scalars; in general, V can be a sequence of vectors. The query and key matrices Q, K can be X itself or outputs of several neural network layers on X. Note that the softmax operation is with respect to each column of QK^{T}/\sqrt{D}, i.e., the i^{th} output is

$${\sum }_{j = 1}^{N} \frac{exp ( ( {q}_{i} {k}_{j}^{T} ) / \sqrt{D}}{{\sum }_{{j}^{′} = 1}^{N} exp ( ( {q}_{i} {k}_{{j}^{′}}^{T} ) / \sqrt{D}} {v}_{j} .$$

Following Nguyen et al. (2022), setting Q=K, then there exists a feature map such that for any i, j∈[N], [symbol] ϕ(Xⱼ), ϕ(Xᵢ) [symbol] =exp((qᵢkⱼ^{T})/\sqrt{D}). Let h(Xᵢ)=Σ_{j′}^{N} exp((qᵢk_{j′}^{T})/\sqrt{D}). The i^{th} output of the attention layer can be written as

$${\sum }_{j = 1}^{N} \frac{{v}_{j}}{h ( {X}_{j} )} 〈 ϕ ( {X}_{j} ) , ϕ ( {X}_{i} ) 〉 . \qquad ( 5 )$$

This formula recovers the support vector expansion in Equation (4) if vⱼ/h(Xⱼ)=α*ⱼWⱼ.

Conversely, under mild regularities, the optimal balancing weight α*ⱼ can be read off from vⱼ/h(Xⱼ)W_j if the attention weight is optimized globally using a crafted loss function. Details are presented in Algorithm ALG in the next section. The intuition is that this loss function, when optimized globally, recovers attention weights that solve the primal SVM problem. Thus it recovers the support vector expansion, which connects the attention weight to the optimal balancing weight. The correctness of the algorithm is summarized in the following theorem.

THEOREM 1 (INFORMAL): under mild regularities on X, Algorithm ALG recovers the optimal balancing weight at the global minimum of LOSS FUNC.

### Practical Algorithm Towards Causal Transformers Optimal Balancing Via Self-Attention

Comparing Eq. (5) and Eq. (4), a training procedure is sought such that

$${\sum }_{j = 1}^{N} \frac{{v}_{j}}{h ( {X}_{j} )} ϕ ( {X}_{j} )$$

recovers the optimal β* that solves primal SVM in Eq. (2). Note that Eq. (2) corresponds to a constrained optimization problem that is unsuitable for gradient descent methods. However, it is equivalent to an unconstrained optimization problem by minimizing the penalized hinge loss (Hastie et al., 2009)

$$\frac{λ}{2} {‖ β ‖}^{2} + {\sum }_{j = 1}^{N} 1 - {W}_{i} 〈 β , ϕ ( {X}_{i} ) 〉 + {β}_{0} .$$

This motivates the use of the following loss function:

$${ℒ}_{θ} = \frac{λ}{2} {‖ {\sum }_{j = 1}^{N} \frac{{v}_{j}}{h ( {X}_{j} )} ϕ ( {X}_{j} ) ‖}^{2} + {[ 1 - W softmax ( {KK}^{T} / \sqrt{D} ) V + {β}_{0} ]}_{+} . \qquad ( 6 )$$

Here θ is used to subsume all the learned parameters, including V and parameters of the layers (if any) to obtain K. θ is learnt via gradient descent on Eq. (6). Note that the penalization can be computed exactly by using the formula of inner product of features, i.e.,

$${‖ {\sum }_{j = 1}^{N} \frac{{v}_{j}}{h ( {X}_{j} )} ϕ ( {X}_{j} ) ‖}^{2} = {\sum }_{i , j = 1}^{N} \frac{{v}_{i} {v}_{j} exp ( {k}_{i} {k}_{j}^{T} / \sqrt{D} )}{h ( {X}_{i} ) h ( {X}_{j} )} .$$

Theorem 1 guarantees that under mild regularities, the optimal parameters lead to the optimal balancing weights in terms of the adversarial squared error. This adversarial squared error is computed using an unit-ball RKHS defined by ϕ. The optimal balancing weights can be obtained via

$${α}_{j}^{*} = \frac{{v}_{j}}{h ( {X}_{j} ) {W}_{j}} .$$

Note that for this result to hold, arbitrary mapping can be used to obtain kᵢ from Xᵢ, thus allowing for the incorporation of flexible neural network architecture. The method is summarized in Algorithm 1.

Algorithm 1 CINA

1: Input: Covariates X and treatment W.
2: Output: Optimal balancing weight α*.
3: Parameters: θ (including V), step size η.
4: while not converged do
5: Compute K using forward pass.
6: Update θ ← θ − η∇ [symbol] _{θ}.
7: return V/h(X)W.

### Inference on Multiple Datasets

To enable direct inference of treatment effects, multiple datasets are considered denoted as [symbol] ₘ={(Xᵢ, Tᵢ, Yᵢ)} for m∈[M]. Each dataset [symbol] ₘ contains Nₘ units and follows the description above. Datasets of different sizes are allowed for, mimicking real-world data gathering procedures, where a large consortium of datasets in a similar format may exist. The setting encapsulates cases where individual datasets are created by distinct causal mechanisms or rules; however, different units within a single dataset should be generated via the same causal model.

Algorithm 1 shows how one can read off the optimal weights α* from a trained model with attention as its last layer in a single dataset. Note that the value vector V is encoded as a set of parameters in this setting. On a new dataset, the values of h(X) and W are changed, and thus the optimal V that minimizes [symbol] _{θ} should also differ from the encoded parameters. To account for this, the value vector V is encoded as a transformation of h(X) and W. Denote the parameters of this transformation as ϕ. ϕ is learnt by minimizing [symbol] _{θ} on the training datasets in an end-to-end fashion. Then on a new dataset not seen during training, its optimal balancing weight α* can be directly inferred via V/h(X)W where V and h(X) are direct output using the forward pass of the trained model. This procedure is summarized in Algorithm 2 and Algorithm 3.

| Algorithm 2 CINA | |
|---|---|
| (multi-dataset version). | Algorithm 3 Inference. |
| 1: Input: Training datasets | 1: Input: Testing dataset [symbol] _{M+1}, |
| [symbol] ₁, . . . [symbol] _{M}. | trained model. |
| 2: Parameters: θ (including | 2: Output: Estimated sample |
| ϕ), step size η. | average treatment effect \hat{τ}. |
| 3: while not converged | 3: Compute h(X), V using |
| do | forward pass. |
| 4: for m ϵ [M] do | 4: Compute α = V/h(X)W. |
| 5: Compute K, V using | 5: return αY. |
| forward pass. | |
| 6: Update θ ← θ − η∇ [symbol] _{θ}. | |

Intuitively, the transformation that encodes for V approximates the solution to the optimization problem in Eq. (2). It enjoys the benefit of fast inference on a new dataset. It is worth noting that ground-truth labels are not required for any individual optimization problems as the parameters are learned fully end-to-end. This reduces the computational burden of learning in multiple steps, albeit unavoidable trade-off in terms of accuracy.

### Proof of Proposition 1

Proof. First, it is straightforward to show that the IPW estimator of the ground truth treatment effect \hat{δ}^{IPW}(T) can be re-written in terms of the population mean estimator, \hat{δ}:

$${\hat{δ}}^{IPW} ( T ) := \hat{δ} + \frac{1}{N} 〈 {Y}^{T = 1} ( B ) , w ( B ) - 1 〉 + \frac{1}{N} 〈 {Y}^{T = 0} ( B ) , 1 〉 - \frac{1}{N} 〈 {Y}^{T = 0} ( D \backslash B ) , \frac{1}{w ( D \backslash B ) - 1} 〉 - \frac{1}{N} 〈 {Y}^{T = 1} ( D \backslash B ) , 1 〉$$

That is, the inverse probability weighted estimation of groundtruth treatment effect \hat{δ}^{IPW}(T) is derived from an inverse probability weighted population mean of the outcome vector \hat{δ}.

Similarly, a similar relationship for the IPW model treatment effect estimator \hat{δ}_{M}^{IPW}(T) can be derived:

$${\hat{δ}}_{M}^{IPW} ( T ) := {\hat{δ}}_{M} + \frac{1}{N} 〈 {Y}_{M}^{T = 1} ( B ) , w ( B ) - 1 〉 + \frac{1}{N} 〈 {Y}_{M}^{T = 0} ( B ) , 1 〉 - \frac{1}{N} 〈 {Y}_{M}^{T = 0} ( D \backslash B ) , \frac{1}{w ( D \backslash B ) - 1} 〉 - \frac{1}{N} 〈 {Y}_{M}^{T = 1} ( D \backslash B ) , 1 〉 . \\ By setting : \\ f ( B ) = \frac{1}{N} 〈 {Y}^{T = 1} ( B ) , w ( B ) - 1 〉 + \frac{1}{N} 〈 {Y}^{T = 0} ( B ) , 1 〉 - \frac{1}{N} 〈 {Y}^{T = 0} ( D \backslash B ) , \frac{1}{w ( D \backslash B ) - 1} 〉 - \frac{1}{N} 〈 {Y}^{T = 1} ( D \backslash B ) , 1 〉 , \\ g ( v , B ) = \frac{1}{N} 〈 v ( B ) * V ( {Y}^{T = 1} ( B ) ) , w ( B ) - 1 〉 + \frac{1}{N} 〈 v ( B ) * V ( {Y}^{T = 0} ( D \backslash B ) ) , 1 〉 - \frac{1}{N} 〈 v ( D \backslash B ) * V ( {Y}^{T = 0} ( D \backslash B ) ) , \frac{1}{w ( D \backslash B ) - 1} 〉 - \frac{1}{N} 〈 v ( D \backslash B ) * V ( {Y}^{T = 1} ( D \backslash B ) ) , 1 〉 ,$$

then under Assumption A, the first conclusion of the proposition is arrived at, that the estimation error of \hat{δ}^{IPW}(T) and \hat{δ}_{M}^{IPW}(T) can be further decomposed as

$${\hat{δ}}^{IPW} ( T ) = \hat{δ} + f ( B ) , \\ {\hat{δ}}_{M}^{IPW} ( T ) := {\hat{δ}}_{M} + f ( B ) + g ( v , B ) .$$

Therefore, \hat{Δ}^{Pairs}(M, T) and \hat{Δ}(M, T) are now given by

$${\hat{Δ}}^{Pairs} ( M , T ) = {\hat{δ}}_{M} - \hat{δ} + g ( v , B ) \\ \hat{Δ} ( M , T ) = {\hat{δ}}_{M} - \hat{δ} - f ( B ) ,$$

respectively. Their estimation error is then given by

$$e ( {\hat{Δ}}^{Pairs} ( M , T ) ) = {\hat{δ}}_{M} - \hat{δ} + g ( v , B ) - Δ ( M ) , \\ e ( \hat{Δ} ( M , T ) ) = {\hat{δ}}_{M} - \hat{δ} - f ( B ) - Δ ( M ) .$$

According to delta method Casella and Berger [2021], both \sqrt{N}e(\hat{Δ}^{Pairs}(M, T)) and \sqrt{N}e(\hat{Δ}(M, T)) are asymptotically normal with zero under Assumption B. However, their variances will differ. The variances of each estimator cam then be computed.

First note that g(v, B) can be rewritten as

$$g ( v , B ) = \frac{1}{N} 〈 v * b * V ( {Y}^{T = 1} ) , w - 1 〉 + \frac{1}{N} 〈 v * b * V ( {Y}^{T = 0} ) , 1 〉 - \frac{1}{N} 〈 v * ( 1 - b ) * V ( {Y}^{T = 0} ) , \frac{1}{w - 1} 〉 + \frac{1}{N} 〈 v * ( 1 - b ) * V ( {Y}^{T = 1} ) , 1 〉 ,$$

where bᵢ is the Bernoulli random variable with P(bᵢ=1)=pᵢ, and bᵢ=1 if i∈B. Without loss of generality, here it is additionally assumed that v has zero mean to further simplify the notational complexity. The proof also holds for the non-zero mean case trivially. Therefore, note also that v is independent from (Y^{T}(i), bᵢ):

[symbol]

ov(Y^{T=t}^{ₐ}(i), vᵢbᵢVᵢ(Y^{T=t}^{_{b}}(i)))= [symbol] (vᵢbᵢ) [symbol] ov(Y^{T=t}^{ₐ}(i), Vᵢ(Y^{T=t}^{_{b}}(i)))=0

holds for all i and all treatments tₐ and t_{b}. Similarly:

[symbol]

ov(Y_{M}^{T=t}^{ₐ}(i), vᵢbᵢVᵢ(Y^{T=t}^{_{b}}(i)))=0.

Therefore, it is not hard to show that [symbol] ov(g(v, B), \hat{δ}_{M})=0. Thus:

$$𝕍ar [ \sqrt{N} e ( {\hat{Δ}}^{Pairs} ( M , T ) ) ] = 𝕍ar [ \sqrt{N} ( {\hat{δ}}_{M} - \hat{δ} ) ] + 𝕍ar [ \sqrt{N} g ( v , B ) ] = 𝕍ar [ {Y}_{M}^{T = 1} - {Y}_{M}^{T = 0} + {Y}^{T = 1} - {Y}^{T = 0} ] + 𝕍ar [ \sqrt{N} g ( v , B ) ] \\ 𝕍ar [ \sqrt{N} e ( \hat{Δ} ( M , T ) ) ] = 𝕍ar [ \sqrt{N} ( {\hat{δ}}_{M} - \hat{δ} ) ] + 𝕍ar [ \sqrt{N} f ( B ) ] = 𝕍ar [ {Y}_{M}^{T = 1} - {Y}_{M}^{T = 0} + {Y}^{T = 1} - {Y}^{T = 0} ] + 𝕍ar [ \sqrt{N} f ( B ) ] . \\ Since {b}_{i} ( 1 - {b}_{i} ) = 0 : 𝔼 [ {v}_{i} {b}_{i} {V}_{i} ( {Y}_{i}^{T = {t}_{a}} ) {v}_{i} ( 1 - {b}_{i} ) {V}_{i} ( {Y}_{i}^{T = {t}_{b}} ) ] = 0. \\ Therefore : 𝕍ar [ g ( v , B ) ] = 𝕍ar [ \frac{1}{N} 〈 v * b * V ( {Y}^{T = 1} ) , w - 1 〉 ] + 𝕍ar [ \frac{1}{N} 〈 v * b * V ( {Y}^{T = 0} ) , 1 〉 ] + 𝕍ar [ \frac{1}{N} 〈 v * ( 1 - b ) * V ( {Y}^{T = 0} ) , \frac{1}{w - 1} 〉 ] + 𝕍ar [ \frac{1}{N} 〈 v * ( 1 - b ) * V ( {Y}^{T = 1} ) , 1 〉 ] .$$

Since v has zero mean and variance σᵥ² and is independent of (Yᵢ^{T}, bᵢ) as in Assumption A, this expression can be further simplified as, according to the rules of variance of the product of independent variables:

$$𝕍ar [ g ( v , B ) ] = \frac{1}{{N}^{2}} 〈 {σ}_{v}^{2} * p * 𝔼 ( {V ( {Y}^{T = 1} )}^{2} ) , {( w - 1 )}^{2} 〉 +$$

$$\frac{1}{{N}^{2}} 〈 {σ}_{v}^{2} * p * 𝔼 ( {V ( {Y}^{T = 0} )}^{2} ) , 1 〉 +$$

$$\frac{1}{{N}^{2}} 〈 {σ}_{v}^{2} * ( 1 - p ) * 𝔼 ( {V ( {Y}^{T = 0} )}^{2} ) , \frac{1}{w - 1} 〉 +$$

$$\frac{1}{{N}^{2}} 〈 {σ}_{v}^{2} * ( 1 - p ) * 𝔼 ( {V ( {Y}^{T = 1} )}^{2} ) , 1 〉 + \frac{{σ}_{v}^{2}}{{N}^{2}} [ 〈 {p ( w - 1 )}^{2} +$$

$$( 1 - p ) , 𝔼 ( {V ( {Y}^{T = 1} )}^{2} ) 〉 + 〈 \frac{1 - p}{w - 1} + ( p ) , 𝔼 ( {V ( {Y}^{T = 0} )}^{2} ) 〉 ] <$$

$$\frac{1}{{N}^{2}} [ 〈 {p ( w - 1 )}^{2} + ( 1 - p ) , 𝔼 ( {( {Y}^{T = 1} )}^{2} ) 〉 +$$

$$〈 \frac{1 - p}{w - 1} + ( p ) , 𝔼 ( {( {Y}^{T = 0} )}^{2} ) 〉 ] = 𝕍ar [ f ( B ) ] ,$$

where the third equality is due to the fact that σᵥ² [symbol] [(VᵢY^{T=t}(i))²]< [symbol] [Y^{T=t}(i)²]. Therefore, it is finally concluded that the variances of the error estimators will satisfy:

[symbol]

ar[\sqrt{N}e(\hat{Δ}^{Pairs}(M, T))]< [symbol] ar[\sqrt{N}e((M, T))].

### Additional Details for Experiment (B.1 Implementation Details)

The csuite dataset used in examples above is an assortment of synthetic datasets first developed by [Geffner et al., 2022], for the purpose of evaluating both causal inference and discovery algorithms. They contain datasets ranging from small to medium scale (2-12 nodes), generated through carefully constructed Bayesian networks with additive noise models. All dataset in the collection includes a training set with 2,000 samples and 1 or 2 intervention or counterfactual test sets. The intervention test sets consist of factual variables, factual values, treatment variable, treatment value, reference treatment value, and an effect variable. More specifically, our three datasets corresponds to the following datasets:
1) nonlin_simpson (csuite_1): An example of Simpson's Paradox [Blyth, 1972] using a continuous SEM. The dataset is constructed so that Cov(X₁, X₂) has the opposite sign to Cov(X₁, X₂|X₀). Estimating the treatment effects correctly in this SEM is highly sensitive to accurate causal discovery. The structural equations are

$${X}_{0} \sim N ( 0 , 1 ) \\ {X}_{1} \sim s ( 1 - {X}_{0} ) + \sqrt{\frac{3}{20}} {Z}_{1} \\ {X}_{2} \sim tanh ( 2 {X}_{1} ) + \frac{3}{2} {X}_{0} - 1 + tanh ( {Z}_{2} ) \\ {X}_{3} \sim 5 tanh ( \frac{{X}_{2} - 4}{5} ) + 3 + \frac{1}{\sqrt{10}} {Z}_{3} \\ where {Z}_{1} , {Z}_{2} \sim N ( 0 , 1 ) and {Z}_{3} \sim Laplace ( 1 )$$

are mutually independent and independent of X₀, s(x)=log(1+exp(x)) is the softplus function. Constants were chosen so that each variable has a marginal variance of (approximately) 1.
2) chain_lingauss (csuite_2): Simulated from the graph X₀→X₁→X₂ with linear 404 relationship. Ensure X₀, X₁ and X₂ have same standard deviation (1), then this in turns into structural equations:

$${X}_{0} \sim 𝒩 ( 0 , 1 ) \\ {X}_{1} \sim \sqrt{\frac{2}{2}} {X}_{0} + \sqrt{\frac{1}{3}} 𝒩 ( 0 , 1 ) \\ {X}_{2} \sim \sqrt{\frac{2}{3}} {X}_{1} + \sqrt{\frac{1}{3}} 𝒩 ( 0 , 1 ) .$$

3) fork_lingauss (csuite_3): Simulated from the graph X₀←X₁→X₂ with linear relationship. Turns into structural equations:

$${X}_{0} \sim 𝒩 ( 0 , 1 ) \\ {X}_{1} \sim \sqrt{\frac{2}{2}} {X}_{0} + \sqrt{\frac{1}{3}} 𝒩 ( 0 , 1 ) \\ {X}_{2} \sim \sqrt{\frac{2}{3}} {X}_{0} + \sqrt{\frac{1}{3}} 𝒩 ( 0 , 1 ) .$$

### Causal Model Details

In the methods set out above, a wide range of machine learning based causal inference methods to evaluate the performance of causal error estimators have been included. They can be roughly divided into 4 categories: double machine learning methods, doubly robust learning methods, ensemble causal methods, and orthogonal methods. All methods are implemented using EconML [Battocchi et al., 2019], as detailed below:
1) DML Linear: A linear double machine learning model [Chernozhukov et al., 2018], which uses an un-regularized final stage linear model for heterogenous treatment effect. Given that it is an unregularized low dimensional final model, this class also offers confidence intervals via asymptotic normality arguments. Random forests with default settings are used for first stage estimations.
2) DML Kernel: kernel DML with random Fourier feature approximations [Nie and Wager, 2021] and uses a ElasticNet regularized final model. Random forests with default settings are also used for first stage estimations. The other configurations are kept as default.
3) Causal Forest causal random forest (or forest DML) [Wager and Athey, 2018, Athey et al., 2019]. The number of estimators is set to 100, number of minimum samples of leaf is set to 10, the number of samples to use for each subsample that is used to train each tree is set as 0.5. The others are kept as default. For effect and outcome models, Lasso with cross-validation is used.
4) DR Linear doubly robust learning with a final linear model. Regression model for [symbol] [Y|X, W, T] is set to random forest models. The propensity model is set to a logistic regression model.
5) DR Forest doubly robust learning with subsampled honest forest regressor. Regression model for [symbol] [Y|X, W, T] is set Gradient Boosting Regressor; and the propensity model is set to a random forest classifier. For other hyperparameters the minimum number of samples required to be at a leaf is set to be 10, and the minimum weighted fraction of the sum total of weights required is set to be at a leaf node to be 0.1
6) Ortho Forest: orthogonal forest learning, a combination of causal forests and double machine learning that allow for controlling for a high-dimensional set of confounders, while at the same time estimating non-parametrically the heterogeneous treatment effect on a lower dimensional set of variables. Lasso with cross-validation is used as the estimator for residualizing both the treatment and the outcome at each leaf; and switch to weighted Lassos at prediction time.
7) DR Ortho Forest: doubly robust orthogonal forest, a variant of the Orthogonal Random Forest that uses the doubly robust moments for estimation as opposed to the DML moments. Similarly, logistic regression models are used for residualizing the treatment at each leaf for both stages; and Lasso with cross-validation for the corresponding estimators for residualizing the outcomes. At prediction time, weighted Lasso is used instead.

### Evaluation Metrics

Throughout all experiments, the performance of the estimators is measured by the following metrics: the variance, the bias, and the MSE of the causal error estimation. More concretely, with a slight abuse of notation, let \hat{Δ}(M, T) denote the estimated causal error (from any estimation method). Then, the evaluation metrics are defined as:

$$Variance := {𝔼}_{T} [ {\hat{Δ} ( M , T )}^{2} ] - {{𝔼}_{T} [ \hat{Δ} ( M , T ) ]}^{2} \\ Bias := {𝔼}_{T} [ \hat{Δ} ( M , T ) - Δ ( M ) ] \\ MSE := {𝔼}_{T} [ {( \hat{Δ} ( M , T ) - Δ ( M ) )}^{2} ] .$$

All expectations are taken over the treatment assignment plans T. In practice, 100 random realizations of treatment assignments are drawn and estimate all three metrics.

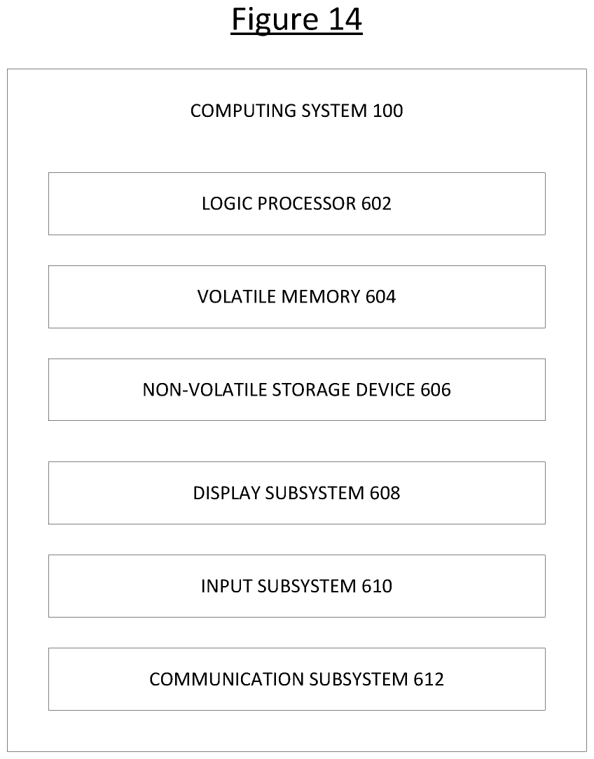

FIG. 14 schematically shows a non-limiting example of a computing system 600, such as a computing device or system of connected computing devices, that can enact one or more of the methods or processes described above, including the filtering of data and implementation of the structured knowledge base described above. Computing system 600 is shown in simplified form. Computing system 600 includes a logic processor 602, volatile memory 604, and a non-volatile storage device 606. Computing system 600 may optionally include a display subsystem 608, input subsystem 610, communication subsystem 612, and/or other components not shown in FIG. 14. Logic processor 602 comprises one or more physical (hardware) processors configured to carry out processing operations. For example, the logic processor 602 may be configured to execute instructions that are part of one or more applications, programs, routines, libraries, objects, components, data structures, or other logical constructs. The logic processor 602 may include one or more hardware processors configured to execute software instructions based on an instruction set architecture, such as a central processing unit (CPU), graphical processing unit (GPU) or other form of accelerator processor. Additionally or alternatively, the logic processor 602 may include a hardware processor(s)) in the form of a logic circuit or firmware device configured to execute hardware-implemented logic (programmable or non-programmable) or firmware instructions. Processor(s) of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 602 may be virtualized and executed by remotely accessible, networked computing devices configured in a cloud-computing configuration. In such a case, these virtualized aspects are run on different physical logic processors of various different machines. Non-volatile storage device 606 includes one or more physical devices configured to hold instructions executable by the logic processor 602 to implement the methods and processes described herein. When such methods and processes are implemented, the state of non-volatile storage device 606 may be transformed—e.g., to hold different data. Non-volatile storage device 606 may include physical devices that are removable and/or built-in. Non-volatile storage device 606 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 606 may include non-volatile, dynamic, static, read/write, read-only, sequential-access, location-addressable, file-addressable, and/or content-addressable devices. Volatile memory 604 may include one or more physical devices that include random access memory. Volatile memory 604 is typically utilized by logic processor 602 to temporarily store information during processing of software instructions. Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program-and application-specific standard products (PSSP/ASSPs), system-on-a-chip (SOC), and complex programmable logic devices (CPLDs), for example. The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 608 may be used to present a visual representation of data held by non-volatile storage device 606. The visual representation may take the form of a graphical user interface (GUI). As the herein-described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices. When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the internet. The term computer readable media as used herein may include computer storage media. Computer storage media may include volatile and non-volatile, removable and nonremovable media (e.g., volatile memory 604 or non-volatile storage 606) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 600 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

According to a first aspect herein, there is provided a computer implemented method comprising: receiving a dataset comprising a covariate matrix, a treatment vector, and an outcome vector; generating, using a trained causal model applied to the dataset, an inverse probability weighted (IPW) model estimation of a treatment effect; estimating an inverse probability weighted estimation of a groundtruth treatment effect is estimated; and calculating a causal treatment error based on the inverse probability weighted model estimation of the treatment effect and the inverse probability weighted estimation of the groundtruth treatment effect.

The IPW estimation of the groundtruth treatment effect may be computed independently of the trained causal model.

The inverse probability weighted estimation of the groundtruth treatment effect may be an inverse probability weighted population mean of the outcome vector.

The method may comprise determining a treatment action based on the causal treatment error, and performing the treatment action on a physical system.

The method may be applied with multiple trained causal models, resulting in respective calculated causal treatment errors for the multiple trained causal models.

The method may comprise selecting a first trained causal model of the multiple trained causal models based on the respective calculated treatment errors.

The method may comprise performing an action on a physical system based on the selected first trained causal model.

For example, a treatment action may be performed on the physical system based on the estimation of the treatment effect generated using the first trained causal model.

One example of a causal inference model is the propensity score matching method, to which the causal error estimation mechanism may be applied.

A propensity score matching method may be trained by: receiving a training dataset specific to a domain, the training dataset comprising a covariate matrix and a treatment vector, the training dataset obtained by selectively performing treatment actions on at least one physical system; training a propensity score model using the training dataset, resulting in a trained propensity score model.

An estimation of the treatment effect may be generated using the propensity score matching method by: computing propensity scores for each unit in the dataset using the trained propensity score model; matching treated and control units based on their propensity scores; estimating the causal effect associated with the treatment vector based on the matched pairs of treated and control units; based on the causal effect, determining a further treatment action; and performing the treatment action on the physical system.

Another example of a causal inference model is a difference-in-differences (DID) method, which can also be applied with the causal error estimation mechanism.

A DID method may be trained by: receiving a training dataset specific to a domain, the training dataset comprising a covariate matrix, a treatment vector, and an outcome vector, the training dataset obtained by selectively performing treatment actions on at least one physical system before and after a specific intervention.

An estimation of the treatment effect may be generated using the DID method by: computing a difference in average outcome between treatment and control groups before and after the specific intervention in the dataset; estimating a causal effect associated with the treatment vector based on the difference; based on the causal effect, determining a further treatment action; and performing the treatment action on the physical system.

A third example of a causal inference model is an outcome modelling method, which can also be applied with the causal error estimation mechanism.

The outcome modelling method may be trained by: receiving a training dataset specific to a domain, the training dataset comprising a covariate matrix, a treatment vector, and an outcome vector, the training dataset obtained by selectively performing treatment actions on at least one physical system; training an outcome model using the training dataset, resulting in a trained outcome model.

An estimation of the treatment effect may be generated using the outcome modelling method by: applying the trained outcome model to the dataset; estimating a causal effect associated with the treatment vector based on the predicted outcomes generated by the trained outcome model; based on the causal effect, determining a further treatment action; and performing the treatment action on the physical system.

The outcome modelling method may involve various regression techniques, such as linear regression, logistic regression, or machine learning algorithms like decision trees, support vector machines, and neural networks, to model the relationship between the treatment vector, covariate matrix, and outcome vector. By leveraging these techniques, the method can estimate causal effect of the treatment on the outcome while accounting for the influence of the covariates.

Another example of a causal inference model (referred to herein as a causal foundational model) is described, to which the causal error estimation mechanism may be applied.

The causal inference model may be trained by: receiving a first training dataset specific to a first domain, the first training dataset comprising a first covariate matrix and a first treatment vector, the first training dataset obtained by selectively performing first treatment actions on at least one first physical system; receiving a second training dataset specific to a second domain, the second training dataset comprising a second covariate matrix and a second treatment vector, the second dataset obtained by selectively performing second treatment actions on at least one second physical system; training using the first training dataset and the second training dataset a causal inference model based on a training loss that quantifies error between each treatment vector and a corresponding forward mode output computed by the causal inference model, resulting in a trained causal inference model.

An estimation of the treatment effect may be generated using the causal foundational model by: computing a rebalancing weight vector using the trained causal inference model applied to a third dataset specific to a third domain, the third dataset comprising a third covariate matrix, a third treatment vector and a third outcome vector, the third dataset obtained by selectively performing third treatment actions on a third physical system; estimating based on the third outcome vector and the rebalancing weight vector a causal effect associated with the third treatment vector; based on the causal effect, determining a further treatment action; and performing the first treatment action on at least one target physical system belonging to the third domain.

The third dataset may be specific to a third domain, and it may be that the causal inference model is not exposed to any data from the third domain during training.

The second training dataset and the third dataset may each be non-randomized.

The at least one third system may comprise the at least one target physical system.

The causal inference model may generate during training: a first output value, wherein the forward mode output corresponding to the first training dataset is computed based on the first output value and a first normalization factor computed from the first covariate matrix, and a second output value, wherein the forward mode output corresponding to the second training dataset is computed based on the second output value and a second normalization factor computed from the first second matrix. The rebalancing weight vector may be computed based on: a third output value computed by the trained causal inference model, the third treatment vector, and a third renormalization factor computed from the third covariate matrix.

Another aspect herein provides a computer system comprising: at least one memory configured to store computer-readable instructions; and at least one hardware processor coupled to the at least one memory, wherein the computer-readable instructions are configured to cause the at least one hardware processor to implement the method of any aspect or embodiment herein.

Another aspect herein provides computer-readable storage media embodying computer readable instructions, the computer-readable instructions configured upon execution on at least one hardware processor to cause the at least one hardware processor to implement the method of any aspect or embodiment herein.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A computer-implemented method, comprising:
receiving a dataset comprising a covariate matrix, a treatment vector, and an outcome vector;
generating, using a trained causal model applied to the dataset, an inverse probability weighted (IPW) model estimation of a treatment effect;
computing an inverse probability weighted (IPW) estimation of a groundtruth treatment effect; and
calculating a causal treatment error based on the IPW model estimation of the treatment effect and the IPW estimation of the groundtruth treatment effect.

2. The method of claim 1, wherein the IPW estimation of the groundtruth treatment effect is computed independently of the trained causal model.

3. The method of claim 1, wherein the IPW estimation of the groundtruth treatment effect is derived from an inverse probability weighted population mean of the outcome vector.

4. The method of claim 1, wherein the method further comprises determining a treatment action based on the causal treatment error, and performing the treatment action on a physical system.

5. The method of claim 1, wherein multiple trained causal models are used, wherein a respective calculated treatment error is calculated for each trained causal model of the multiple trained causal models.

6. The method of claim 5, wherein the method further comprises selecting a first trained causal model of the multiple trained causal models based on the respective calculated treatment errors.

7. The method of claims 6, wherein the method comprises performing an action on a physical system based on the selected first trained causal model.

8. The method of claim 7, wherein the method further comprises performing a treatment action on the physical system based on the IPW model estimation of the treatment effect generated using the first trained causal model.

9. The method of claim 1, wherein the trained causal model is a trained propensity score model, wherein the trained propensity score model is trained by:
receiving a training dataset specific to a domain, the training dataset comprising a covariate matrix and a treatment vector, the training dataset obtained by selectively performing treatment actions on at least one physical system; and
training the propensity score model using the training dataset, resulting in a trained propensity score model.

10. The method of claim 9, wherein the IPW model estimation of the treatment effect is generated using a propensity score matching method by:
computing propensity scores for each unit in the dataset using the trained propensity score model;
matching treated and control units based on their propensity scores to generate matched pairs of treated and control units;
estimating a causal effect associated with the treatment vector based on the matched pairs of treated and control units;
based on the causal effect, determining a treatment action; and
performing the treatment action on the physical system.

11. The method of claim 1, wherein the causal model is trained by:
receiving a training dataset specific to a domain, the training dataset comprising the covariate matrix, the treatment vector, and the outcome vector, the training dataset obtained by selectively performing treatment actions on at least one physical system before and after a specific intervention; and
training the causal model using the training set, resulting in a trained causal model.

12. The method of claim 11, wherein the IPW model estimation of the treatment effect is generated using a difference-in-difference (DID) method by:
computing a difference in average outcome between treatment and control groups before and after the specific intervention in the dataset;
estimating a causal effect associated with the treatment vector based on the difference in average outcome between treatment and control groups before and after the specific intervention in the dataset;
based on the causal effect, determining a treatment action; and
performing the treatment action on the physical system.

13. The method of claim 1, wherein the causal model is an outcome model, wherein the outcome model is trained by:
receiving a training dataset specific to a domain, the training dataset comprising a covariate matrix, a treatment vector, and an outcome vector, the training dataset obtained by selectively performing treatment actions on at least one physical system; and
training the outcome model using the training dataset, resulting in a trained outcome model.

14. The method of claim 13, wherein the IPW model estimation of the treatment effect is generated using an outcome modelling method by:
applying the trained outcome model to the dataset to generate predicted outcomes;
estimating a causal effect associated with the treatment vector based on the predicted outcomes generated by the trained outcome model;
based on the causal effect, determining a further treatment action; and
performing the treatment action on the physical system.

15. The method of claim 1, wherein the causal model is a causal foundational model, wherein the causal foundational model is trained by:
receiving a first training dataset specific to a first domain, the first training dataset comprising a first covariate matrix and a first treatment vector, the first training dataset obtained by selectively performing first treatment actions on at least one first physical system;
receiving a second training dataset specific to a second domain, the second training dataset comprising a second covariate matrix and a second treatment vector, the second dataset obtained by selectively performing second treatment actions on at least one second physical system;
training using the first training dataset and the second training dataset a causal inference model based on a training loss that quantifies error between each treatment vector and a corresponding forward mode output computed by the causal inference model, resulting in a trained causal inference model.

16. The method of claim 15, wherein the IPW model estimation of the treatment effect is generated using the causal foundational model by:
computing a rebalancing weight vector using the trained causal inference model applied to a third dataset specific to a third domain, the third dataset comprising a third covariate matrix, a third treatment vector and a third outcome vector, the third dataset obtained by selectively performing third treatment actions on a third physical system;
estimating based on the third outcome vector and the rebalancing weight vector a causal effect associated with the third treatment vector;
based on the causal effect, determining a further treatment action; and
performing the first treatment action on at least one target physical system belonging to the third domain.

17. The method of claim 16, wherein the third dataset is specific to a third domain, wherein the causal foundational model is not exposed to data from the third domain during training.

18. The method of claim 16, wherein the causal foundational model generates, during training:
a first output value, wherein the forward mode output corresponding to the first training dataset is computed based on the first output value and a first normalization factor computed from the first covariate matrix; and
a second output value, wherein the forward mode output corresponding to the second training dataset is computed based on the second output value and a second normalization factor computed from the second covariate matrix;
wherein the rebalancing weight vector is computed based on:
a third output value computed by the trained causal inference model, the third treatment vector, and a third renormalization factor computed from the third covariate matrix.

19. A computer system comprising:
a memory configured to store computer-readable instructions; and
a hardware processor coupled to the memory, wherein the computer-readable instructions are configured to cause the hardware processor to:
receive a dataset comprising a covariate matrix, a treatment vector, and an outcome vector;
generate, using a trained causal model applied to the dataset, an inverse probability weighted (IPW) model estimation of a treatment effect;
compute an inverse probability weighted (IPW) estimation of a groundtruth treatment effect; and
calculate a causal treatment error based on the IPW model estimation of the treatment effect and the IPW estimation of the groundtruth treatment effect.

20. Computer-readable storage media embodying computer readable instructions, the computer-readable instructions configured upon execution on a hardware processor to cause the hardware processor to:
receive a dataset comprising a covariate matrix, a treatment vector, and an outcome vector;
generate, using a trained causal model applied to the dataset, an inverse probability weighted (IPW) model estimation of a treatment effect;
compute an inverse probability weighted (IPW) estimation of a groundtruth treatment effect; and
calculate a causal treatment error based on the IPW model estimation of the treatment effect and the IPW estimation of the groundtruth treatment effect.
